(19) United States
(12) Patent Application Publication
(10) Pub. No.: US 2025/0347820 A1
(43) Pub. Date: Nov. 13, 2025

(54) SYSTEMS AND METHODS FOR LOCATING AND MAPPING BURIED UTILITY OBJECTS USING ARTIFICIAL INTELLIGENCE WITH LOCAL OR REMOTE PROCESSING

(71) Applicant: SeeScan, Inc., San Diego, CA (US)

(72) Inventors: Mark S. Olsson, La Jolla, CA (US); Alexander L. Warren, Escondido, CA (US)

(21) Appl. No.: 19/198,495

(22) Filed: May 5, 2025

Related U.S. Application Data
(60) Provisional application No. 63/643,915, filed on May 7, 2024.

(51) Int. Cl. G01V 3/12; G01V 3/17; H04W 4/38

(52) U.S. Cl. CPC G01V 3/12; G01V 3/17; H04W 4/38

(57) ABSTRACT

This disclosure relates generally to systems and methods for locating and mapping buried utility objects using Artificial Intelligence (AI). In an exemplary embodiment, electromagnetic data related to underground utilities and communication systems is collected and provided to a Deep Learning model to build a training set. New data is then collected and provided to the learning model to enable AI to make a prediction as to the type and location of any existing utilities. This predicted data may be used to create a map which may be stored and/or displayed. In some embodiments, the AI (Deep Learning model) processing may be performed locally in a Utility Locator and/or cable drum-reel, and/or remotely in a wireless device such as a mobile phone, laptop, vehicle, etc., and/or in the Cloud.

### CROSS-REFERENCE TO RELATED APPLICATIONS

This application claims priority under 35 U.S.C. § 119(e) to U.S. Provisional Patent Application Ser. No. 63/643,915 entitled SYSTEMS AND METHODS FOR LOCATING AND MAPPING BURIED UTILITY OBJECTS USING ARTIFICIAL INTELLIGENCE WITH LOCAL OR REMOTE PROCESSING, filed May 7, 2024, the content of which is incorporated by reference herein in its entirety for all purposes.

### FIELD

This disclosure relates generally to systems and methods for locating and mapping buried utility objects using Artificial Intelligence (AI). More specifically, but not exclusively, this disclosure relates to systems and methods for collecting electromagnetic data related to underground utilities and communication systems and classifying that data using a Deep Learning Learning model in order to locate and map any existing utilities. The AI (Deep Learning model) processing may be performed locally in a Utility Locator or camera, and/or remotely in a wireless device such as a mobile phone, laptop, vehicle, etc., and/or in the Cloud.

### BACKGROUND

FIG. 1 illustrates different methods for collecting multifrequency electromagnetic data from buried objects associated with utilities or communication systems, as known in the prior art. Underground objects may include power lines, electrical lines, gas lines, water lines, cable and television lines, and communication lines. Power and electrical lines may be single phase, three phase, passive, active, low or high voltage, and low or high current. Various lines may be publicly or privately owned. Data collected from various underground objects may be single frequency or multifrequency data.

Collected multifrequency data may be obtained using a Geo-Locating Receiver (GLR), often referred to as a “utility locator device” or “utility locator” or “locator,” or other devices and methods well known in the art. Collected data may form a suite of data which may include, for example, multifrequency electromagnetic data, imaging data, mapping data which may include depth and orientation data, current and voltage data, even and odd harmonics, active and passive signals, spatial relationships to other lines and objects, fiber optic data, etc. The ability to go out in the field and locate various underground objects or assets associated with utilities and communication systems, store large amounts of data, and quickly and accurately analyze the data to determine asset characteristics such as the types of underground assets, electrical characteristics, what the assets are connected to, and who owns them is currently very limited. It would also be desirable to understand how, for example, a phone system is grounded to other lines since they are all connected. If above ground data was also available, also known as “ground truth data,” this data could also be included in the data suite and be used to determine origin and ownership of assets. For instance, are the underground assets part of the equipment owned by AT&T®, Verizon®, T-Mobile®, the local cable or utility company, etc.? Processing, understanding, and classifying this enormous amount of data requires the ability to learn and notice patterns. This task is too complex for humans to perform but perfectly suited for Artificial Intelligence (AI).

Utility locators typically have some local, i.e. on-board computing capabilities (e.g. processing and memory functionality). The amount of processing available is of course limited to whatever physical computing resources are available, and also to what the processing is being used for. Because of this limitation, high level processing as is typically needed for AI and Neural Networks applications may be severely limited.

What is needed in the art is the ability to automate the process using Deep Learning by providing training data to a Neural Network, and using Artificial Intelligence (AI) to predict, with a very high probability level, specific characteristics of underground objects or assets. Furthermore, it would be highly beneficial to be able to access additional remote processing power such as is readily available in a typical smartphone (e.g. iphone, Android, or other type of mobile phone). In fact, smartphones are well suited for the type of processing necessary for Artificial Intelligence/Neural Network applications.

Accordingly, the present invention is directed towards addressing the above-described problems and other problems associated with collecting very large sets of multifrequency electromagnetic data associated with buried objects, processing that data, and predicting with a high degree of probability the type and source of the buried object associated with the data.

### SUMMARY

This disclosure relates generally to systems and methods for determining and distinguishing buried objects using Artificial Intelligence (AI). More specifically, but not exclusively, this disclosure relates to systems and methods for collecting utility and communication data by using utility locating equipment, or other electromagnetic receiving equipment, to gather and measure multifrequency electromagnetic signals from passive and active lines which are buried and/or underground. Once collected, multifrequency electromagnetic data may be combined with other data, for instance user predefined classifier data, or ground truth data, etc., and provided to a processor which outputs “Training Data.” Neural Networks using AI rely on Training Data to learn and improve analysis and prediction accuracy. Ground truth data may consist of visually observable data that a user would notice about specific assets such as type of asset, location, connections, ownership, utility box or junction data, obstacle data, etc. Obstacle data may be any type of observable obstacle which may or may not make it harder to collect data at a specific location: for instance a wall, pipe, building, signage, waterway, equipment, etc. The training data is then provided to at least one neural network for processing using Artificial Intelligence (AI). By analyzing the training data, and recognizing patterns using Deep Learning, the neural network can classify the collected data based on a predicted probability. Classified data may then be displayed and presented to a user.

Neural machine translation (NMT) uses an artificially produced neural network. This Deep Learning technique, when translating text and/or language, looks at full sentences, not only individual words. Neural networks require a fraction of the memory needed by statistical methods. They also work far faster.

Deep Learning or Artificial Intelligence applications for translation appeared first in speech recognition in the 1990s. The first scientific paper on using neural networks in machine translation appeared in 2014. The article was followed rapidly by many advances in the field. In 2015 an NMT system appeared for the first time in Open MT, a machine translation competition. From then on, competitions have been filled almost exclusively with NMT tools.

The latest NMT approaches use what is called a bidirectional recurrent neural network, or RNN. These networks combine an encoder which formulates a source sentence for a second RNN, called a decoder. A decoder predicts the words that should appear in the target language. Google uses this approach in the NMT that drives Google Translate. Microsoft uses RNN in Microsoft Translator and Skype Translator. Both aim to realize the long-held dream of simultaneous translation. Harvard's NLP group recently released an open-source neural machine translation system, OpenNMT. Facebook is involved in extensive experiments with open source

NMT, learning from the language of its users (source: http://sciencewise.info /media/pdf/1507.08818v1.pdf).

In one aspect, a user may walk, ride, or drive along a road, street, highway, or various other terrain, while using a locating device with the ability to measure and collect buried or underground multifrequency electromagnetic data at a desired location. The locating device may include a locator, sonde, transmitting antenna, receiving antenna, transceiver, a satellite system, or any other measuring or locating device well known in the art. The assets may include underground lines that are passive or active.

Other forms of data may also be collected using various methods and techniques well known in the art. For instance, data may include imaging data taken from a camera, received data measured by applying a current, voltage, or similar property to an underground line and then measuring the resultant current or voltage at various points along that line or other lines, either by a hardwired connection, or wirelessly, which may also include inductive measurements.

Collected data may include, for example, multifrequency electromagnetic data, imaging data, mapping data which may include depth and orientation data, current and voltage data, even and odd harmonics, active and passive signals, spatial relationships to other lines and objects, fiber optic data, etc. Collected data may be single phase (1ϕ) or multiphase: for example, three phase (3ϕ). Collected data could also include Phase Difference Data. As an example, in the USA where the electrical power utility frequency is 60 Hz, the phase differences between narrow band 60 Hz harmonic signals could be extracted and used as Training Data.

In one aspect, some or all of the collected underground data may be combined with additional data from other sources to form a “Data Suite.” Types of additional data are almost limitless and are well known in the art. For example, additional data may include data already known about underground assets such as type of equipment, orientation, connections, manufacturer, ownership, etc. Additional data may also include observational data observed below ground, for instance seen in an open pipe or trench, or above ground data, such as specific equipment, layout of equipment, manufacturer information placed on equipment, etc. Observed or measured above ground data is also almost limitless and well known in the art: for instance, utility boxes, power poles and lines, radio and cellular antennas, transformers, observable connections, line and pipe paths, conduits, etc.

Once collected, the Suite of Data by itself, or in combination with user defined underground asset classification or category data, is provided as Training Data, also known as a “Training Data Suite,” for Deep Learning to one or more neural networks. The neural networks are programmed to use Artificial Intelligence (AI) for determining with a high probability of accuracy specific information about the underground or buried assets. In one aspect, specific information or characteristics may include types of underground assets, electrical characteristics, what the assets are connected to, and who owns them. Some of this information will be geographic location specific. For instance, in the USA and Canada, household and business power is typically delivered at 110 VAC, 60 Hz; however, in Europe it is delivered at 230 VAC, 50 Hz. There are of course many other examples. Also, the types of underground assets, types of connections, and companies who own them may vary greatly from city to city, among states, regions, and from country to country.

In another aspect, specific information could include right of way information, location and/or direction information, and even damaged asset information. As an example, if it is known or learned that specific electrical characteristics are present at the input of an electrical line or powerline, it may be expected that specific electrical characteristics should be present at the output. However, if the output is not as expected, it could be assumed that the line itself or other related equipment is damaged or malfunctioning.

In one aspect, the training data would be dynamically updated. Updates could be incremental, for instance at specific time intervals, or continuous. Also, training data sets could be different in different geographic locations. For instance, training data sets could be updated to take into account different electrical and other characteristics due to local, regional, or country differences, etc. As an example, AI predicted results could be compared to known results in order to test result accuracy. The term “predicted results” takes into account the fact that AI is making a probability or likelihood prediction that the data it has analyzed corresponds to a certain utility system, and to specific characteristics of the system.

In another aspect, Testing Data, and/or Quality Metrics could be provided to the Neural Network to get a confidence level of the accuracy of and results determined by AI.

In this disclosure the terms “Deep Learning” and “Artificial intelligence (AI)” are used synonymously. However, there is actually a subtle difference. Deep Learning is an AI function that mimics the workings of the human brain in processing data for use in detecting objects, recognizing speech, translating languages, and making decisions. Deep Learning AI is able to learn without human supervision, drawing from data that is both unstructured and unlabeled (source: Investopedia.com). Deep Learning is a subset of machine learning where artificial neural networks, algorithms inspired by the human brain, learn from large amounts of data. Deep Learning allows machines to solve complex problems even when using a data set that is very diverse, unstructured and interconnected (source: Forbes.com). The task of analyzing and making sense of enormous amounts of collected data related to multifrequency electromagnetic data, as well as the addition of additional related data joined to form a Data Suite is too complex for humans to perform but perfectly suited for Artificial Intelligence (AI). In one aspect, AI, which is perfectly suited for pattern recognition, provides a user with classification and type probabilities for underground as well as above ground assets. Results may be provided to a user in numerous ways, including visually rendered on a display, audibly, tactilely, etc.

In another aspect, received and analyzed training data may allow AI to classify or categorize certain types of equipment. As an example, a group of underground objects may exhibit 25 different frequencies with each object having a certain amount of energy or current, each object being at a different depth and orientation from the other objects and the ground at specific locations. AI should be able to use the data to make a probability guess about what kind of utility is underground and even who the owner is if ownership classification data was part of the Data Suite used as training data.

In another aspect, a neural network using AI may learn that in a utility system every two houses have a street crossing and always include installed electricity, cable TV, and phone lines. It may also learn that gas lines are between houses, water meters are present and have leads with certain depths, utilities have certain depths and frequencies, utilities are located with respect to specific addresses on certain positions on the street, and that utilities are running along or across the street. Additionally it may be determined which frequency of passive energy is being measured on a specific utility if you get AM frequencies in the utility and the ration of harmonics on the utility. These are all patterns AI can recognize and use to estimate a probability that the utility is a waterline, or a gas line, or a fiber optic cable, or more specifically for example, an AT&T® fiber optic cable. AI can make this assumption because it has learned that AT&T® uses a certain type of equipment and that the equipment has a certain type of harmonics because it is made, for instance, by Samsung®, and it has learned that other lines are made by other companies.

As another example, observed data included in a Training Data Suite may include a pipe, manhole cover, valve, or utility box that is labeled SDGE (San Diego Gas & Electric). So it can be assumed that this type of equipment has a certain type of frequency. AI can look at all the training data at once and predict with a high probability, that it is, for example, an SDGE, three phase (3ϕ) powerline, that feeds nearby houses with single phase (1ϕ) power, or that it is a powerline going to an industrial feed because it has all of the different and correct 3ϕ harmonics.

The AI could also learn and form associations with the training data. For instance, in one aspect AI could determine there is a traffic light near a specific location, and that waterlines are grounded to a powerline, and that a specific waterline is associated with a specific powerline because the bleeding off of additional harmonic energy into the waterline is different than that bleeding off of additional harmonic energy into the power line. AI might then notice that the same gas line is three blocks down because it has learned how high frequencies bleed off faster than low frequencies, and the fourth house down is starting to bleed off some additional harmonic energy into the gas line ten houses away as well, based on the frequency content of the spectral signature of a given target utility that is close in spatial distance. AI does not need to know physics or do ground modeling as a human would or a computer program would, all AI has to do is recognize patterns, make sense of the patterns, and make sense of the relationship between different patterns.

AI can use its training to output the probability of specific attributes being related to specific underground assets and the utilities the assets are related to. More specifically AI can determine the probability that certain things are related to other things, the nature between the different things, how far away the connections between the different things are, how far the connection between two things might be from where a current or previous measurement was taken based on the difference between the two things, and if some ground truth data was provided as part of the Training Data, very specific information like who owns or operates specific equipment, e.g. AT&T®, Verizon®, T-Mobile®, etc. AI can also be used to distinguish a specific communication standard used by a specific company, for instance 4G vs 5G cellular protocols, etc.

Some prior art systems exist that allow for frequency monitoring and the use of computers to calculate certain system parameters using various methods, for instance using Eigenvalues. However, these systems are very slow and do not allow the processing of large blocks of data in real or near real-time. Even if they could be programmed to accomplish such a task, systems such as these would take days, weeks, or even months to calculate any worthwhile parameters with even a reasonable accuracy. And with very large data sets, a final reliable solution may never be realized.

Current technology, for instance a cellphone, can be used while going down a street to map the position of things that can be seen. This does not really have much value because it is so limited. Deep Learning which uses AI can be used to map the relationship of things that cannot be seen, for instance underground or buried assets.

Processing or preprocessing of Training Data could be performed real-time or at a later time (post-processing). For instance, Collected Data and Other Data could be stored in local or remote memory, including the Cloud, and post-processed (as opposed to real-time processing), and then provided to a Neural Network as Training Data. Additionally, the Neural Network itself could process and analyze the Training Data in real-time, or post-process the data at a later time.

In one aspect, a utility locator gathers raw electromagnetic data (EM data) related to a buried utility line or conductor. This information is then wirelessly streamed via WiFi or any other common communication protocol (preferably with a high bandwidth) to a remote device with AI processing capabilities such as a smartphone, laptop, etc. for utility type and location prediction via a Neural Network running on the remote device.

The EM data may include estimated position and orientation, and current magnitude in the form of a current vector placed in the ground at a position where the EM data indicates a likely position of a buried wire. Also included may be data related to measurement frequency used, frequency band, current strength, and current phase. Basically, this represents a class of raw data related to the location and orientation of the locator which is provided to the Neural Network for processing/predictions, or the raw data may be pre-processed at the locator, and vectors representing the raw data calculated in the world frame can be sent to the remote device for further processing using the Neural Network. In other words data sent to the remote device needs to have dependencies of the locator built into the data, or the data needs to stand alone so its own position and orientation in the world frame are independent of the locator.

At the remote device, a trained AI model is used to analyze locator data, and recognize patterns using the EM data to compute an estimate regarding if a utility is present, what type of utility it is, and its predicted exact location. Many other predictions related to the underground utility could be included as well. For example depth of the utility, owner of the utility, conductor or pipe size, ownership of the utility, etc. AI can also provide a confidence level of the likelihood that the presence and location of a utility is accurate, the kind of utility, e.g. powerline, gas line, big pipe, small pipe, etc. AI is well suited to make these predictions because it is good at recognizing multi-dimensional patterns, and making sense of them. With so much dimensionality, i.e. so much data, standard networks (as opposed to AI/Neural Networks), just can not process this data in a timely and efficient manner. AI, therefore, is much better suited for such tasks.

In one aspect, a high bandwidth WiFi connection is provided between a smartphone (iphone, Android, or another type), and a utility locator. Apple and Android both have tool kits available to facilitate writing applications for this type of purpose. Raw or preprocessed data from the locator is streamed in real-time or near real-time from the utility locator to the smartphone, the phone runs AI to extract utility positions, make estimates about which utilities they are, their location, confidence level of estimates/predictions, and other utility related data predictions. The phone sends the extracted/analyzed information in real-time or near real-time back to the locator, and the locator integrates that information to a user interface (UI) also in real-time or near real-time.

In another aspect, a smartphone can be used as a relay to the Cloud. Some or all of the information from the locator can be streamed to the Cloud via the smartphone for AI processing, the processed data can then be relayed back to the locator using the smartphone. One advantage of Cloud processing is that any preexisting data, e.g. utility data from the same area, can be used in addition to the new data. As an example, similar map trends from the location of a utility survey being walked using a locator, a previous frequency sweep, etc., that provided some previous information related to a specific utility.

In another aspect, if a utility pipe inspection camera cable drum-reel includes WiFi or another wireless protocol communication module, the module can be used as a relay to communicate between a locator and the Cloud. If the locator itself includes a WiFi or other wireless protocol communication module with enough bandwidth, data from the locator may be transmitted directly to the Cloud for AI processing on a Neural Network to obtain a prediction result, and then the prediction data may be sent directly back to the locator for display, and/or sent to another remote device such as a smartphone, laptop, etc., for display.

In some aspects, training data may be sent from a utility locator and/or a camera cable drum-reel along with a trained model that has been created on a Neural Network located on the utility locator and/or the camera cable drum-reel itself to a remote device for AI processing. In another aspect, only the training data may be sent to a remote device, a training model is created in a Neural Network on the remote device, and then the model can be used to process prediction data to obtain a prediction result. The remote device may also relay training data to the Cloud, a prediction model can be created in the Cloud, prediction data may then be relayed from the remote device to the Cloud to be used with the prediction model to obtain a prediction result. Prediction results from the Cloud can then be relayed back to the remote device. Any data from the Cloud or from the remote device may be displayed on the remote device and/or transmitted back to the locator and/or the camera cable drum-reel for display.

In another aspect, prediction data, and/or prediction results may then be used as training data to create a new model. This feedback process may be done a single time, or may be in iterative process.

Locator information may be related to either electrical utilities as detected by EM data, or gas and pipe utilities related to detecting current induced into pipe tracer lines, or detected from pipes using cathodic protection. As an example, AI can be used to determine that there is a similar gas line similar to one previously detected, so it could be the same gas line but 100 feet down the road. It appears to be on the right side of the road as previously determined, as well as about the right depth. All of this data, as well as stored imagery data, mapping data, raw data, and any other available data can be used as training data, and incorporated into a prediction model. The model can then use new raw EM data, new mapping data, along with existing mapping data, utility data, etc. to look for patterns.

In one aspect, AI processing via a Neural Network may be done in the utility locator itself, or in a camera used for utility locating. This processing can be done in real-time or near real-time.

In another aspect, the AI processing may be done in both locally in a utility locator or in a camera, and remotely in a smartphone or other remotely located device with AI processing capabilities. As an example, EM data and other sensor data received by the locator, or image or other sensor data received by the camera can be used as training data. The training data can be used in a neural network located in the locator or the camera to create an AI model. The training data and the model can be streamed to a remote device. New data to be predicted (prediction data) that is received by the locator or the camera can be streamed to the remote device and be input into the AI model in a Neural Network to analyze, and extract a prediction.

In another aspect, the training data can be streamed to a smartphone or other remote device to create an AI model on a Neural Network that resides on the remote device. As previously mentioned, the smartphone or other remote device can also be used as a relay to stream data from the locator or camera to the Cloud. Any AI processing on a Neural Network can then be accomplished in the Cloud. It would be obvious to one skilled in the art that AI processing could also be split up into tasks, some done locally in the locator or camera, some done on a smartphone or other smart device, and some AI processing tasks done in the Cloud. It would also be obvious to one skilled in the art that some of the tasks may be computing tasks, including processing, storing, organizing, etc., that do not require the power of AI processing or a Neural Network to be accomplished.

Different level AI models may be created for different types of processing. As an example, a base model may use EM data to extract patterns, and decide which patterns show a high likelihood of the presence of one or more utilities. In another example, a partial utility model may be used when there is a lower probability that a utility has been located. Any additional data that is available, i.e. previous data located on a remote device or in the Cloud, or additional sensor input data from the locator, a camera, or the remote device itself, or any available data, including mapping data, taken over multiple sessions, can be used in either model to determine which identified patterns should be incorporated into a map.

In another aspect, remote processing may be done at a vehicle or a remote facility or building. For instance, at some work sites, i.e. excavation sites, where locator equipment and cameras/imaging system are used, distributed processing or a separate AI processor may available for data processing as well. Taking advantage of this would make available a higher level of computer power because of the likelihood of a larger source of power that would typically not be available locally at a utility locator or camera/imaging system. For instance, a work truck or other vehicle would have access to at least one on board battery vehicle battery, multiple batteries, or even an available generator to be used for computing/processing tasks on any available computing machines. In some aspects, data could be streamed to a large facility which may even include MWs of running power for data centers which may even have their own cooling towers. This would provide a huge processing advantage over the processing power and level you would be able to carry around in a locator, camera, smartphone, or other handheld or easily transportable device or system.

Wirelessly streaming data bidirectionally using WiFi or another streaming protocol between a vehicle or a facility, either directly or relayed through a smartphone or other remote device, would allow the harnessing of large amounts of processing power not available to a smaller device. Some or all data could also be processed in the Cloud, as previously mentioned. Any information to be displayed could ultimately be sent back to a handheld instrument, such as a smartphone or other remote device, a utility locator, or any other display available to system users.

Outsourcing, so to speak, AI processing to a smartphone which most people already carry, allows a user to leverage the processing capabilities already existing in most smartphones, along with the additional advantage of using the existing communication functionality in smartphones to wirelessly communicate with the Cloud, and/or back to a locator. Other types of conventional, i.e. non-AI or Neural Network processing, can also be done on a smartphone. For instance, algorithmic, i.e. if then, else type filter processing, filtering of signals, and other calculations that do not require the calculating power of AI. If enough bandwidth is available, you can send large amounts of the raw, unfiltered data to a smartphone, and the smartphone can do all of the filtering and display processing. The smartphone's own display can be used, or the processed information can be sent back to a locator for display. Other non-visual ways of providing information to a user are well known in the art, and can be used alone or in combination with a visual display, e.g. audio, tactile, etc. A visual display may render information to a user in the form of raw data, processed data, organized data, filtered data, textual data, mapped, data, etc., or a combination of any of those.

In another aspect, data from a utility locator or camera may be directly sent to a vehicle for display, or the data may be processed using a smartphone and/or the Cloud, and then displayed in the vehicle. The vehicle display may be an on-board display, or a remote device such as an iPad or laptop inside the vehicle. If one or more utility locators are attached to the vehicle, e.g. with a hitch or other attachment, any built in display on the locator will not be able to be seen when inside the vehicle. In this case processed data may not need to be sent back to the locator(s) at all.

In one aspect, logging may be provided to create a historical record of where the locator has been, e.g. position, location, time, date, etc. As an example, EM data from the locator may be sent to an AI model on a smartphone for processing on the phone, once processed the data may be sent back to the locator to display position in real-time or near real-time. Displayed utility data may include estimated position and orientation, magnitude of current, i.e. a current vector placed in the ground at an indicated position, phase, etc. If only a narrow bandwidth is available for communication, vectors already calculated in a real frame can be sent to the smartphone or other remote device for further processing.

In one aspect, locator position in the world frame, and locator orientation in the world frame can be sent to a smartphone, along with offset positions of the utilities with respect to a single position. As an example, you might have 200 different frequencies, and some of those frequencies are being sent and sampled at different rates, e.g. 8 Hz, 64 Hz, PCA (principal component analysis), narrow band, etc. Also, might have DC magnetometry, moving magnetometery around calculating positions of dipoles, etc. Dipole and cylindrical processing can be done in DC. DC is another frequency, in essence its frequency is zero. Similar type processing for both cylindrical and dipole fields can be done in DC, e.g. if we have a 12 channel array we can do the same calculations with DC as in AC.

Various additional aspects, features, and functions are describe below in conjunction with the Drawings.

Details of example devices, systems, and methods that may be combined with the embodiments disclosed herein, as well as additional components, methods, and configurations that may be used in conjunction with the embodiments described herein, are disclosed in co-assigned patents and patent applications including: U.S. Pat. No. 7,009,399, issued Mar. 7, 2006, entitled OMNIDIRECTIONAL SONDE AND LINE LOCATOR; U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 7,221,136, issued May 22, 2007, entitled SONDES FOR LOCATING UNDERGROUND PIPES AND CONDUITS; U.S. Pat. No. 7,276,910, issued Oct. 2, 2007, entitled A COMPACT SELF-TUNED ELECTRICAL RESONATOR FOR BURIED OBJECT LOCATOR APPLICATIONS; U.S. Pat. No. 7,288,929, issued Oct. 30, 2007, entitled INDUCTIVE CLAMP FOR APPLYING SIGNAL TO BURIED UTILITIES; U.S. Pat. No. 7,298,126, issued Nov. 20, 2007, entitled SONDES FOR LOCATING UNDERGROUND PIPES AND CONDUITS; U.S. Pat. No. 7,332,901, issued Feb. 19, 2008, entitled LOCATOR WITH APPARENT DEPTH INDICATION; U.S. Pat. No. 7,443,154, issued Oct. 28, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,336,078, issued Feb. 26, 2008, entitled MULTI-SENSOR MAPPING OMNIDIRECTIONAL SONDE AND LINE LOCATORS; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 7,557,559, issued Jul. 7, 2009, entitled COMPACT LINE ILLUMINATOR FOR BURIED PIPES AND CABLES; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,741,848, issued Jun. 22, 2010, entitled ADAPTIVE MULTICHANNEL LOCATOR SYSTEM FOR MULTIPLE PROXIMITY DETECTION; U.S. Pat. No. 7,755,360, issued Jul. 13, 2010, entitled PORTABLE LOCATOR SYSTEM WITH JAMMING REDUCTION; U.S. Pat. No. 7,825,647, issued Nov. 2, 2010, entitled METHOD FOR LOCATING BURIED PIPES AND CABLES; U.S. Pat. No. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 7,864,980, issued Jan. 4,2011, entitled SONDES FOR LOCATING UNDERGROUND PIPES AND CONDUITS; U.S. Pat. No. 7,948,236, issued May 24, 2011, entitled ADAPTIVE MULTICHANNEL LOCATOR SYSTEM FOR MULTIPLE PROXIMITY DETECTION; U.S. Pat. No. 7,969,151, issued Jun. 28, 2011, entitled PRE-AMPLIFIER AND MIXER CIRCUITRY FOR A LOCATOR ANTENNA; U.S. Pat. No. 7,990,151, issued Aug. 2, 2011, entitled TRI-POD BURIED LOCATOR SYSTEM; U.S. Pat. No. 8,013,610, issued Sep. 6, 2011, entitled HIGH Q SELF-TUNING LOCATING TRANSMITTER; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. patent application Ser. No. 13/769,202, filed Feb. 15, 2013, entitled SMART PAINT STICK DEVICES AND METHODS; U.S. patent application Ser. No. 13/793,168, filed Mar. 11, 2013, entitled BURIED OBJECT LOCATORS WITH CONDUCTIVE ANTENNA BOBBINS; U.S. Pat. No. 8,400,154, issued Mar. 19, 2013, entitled LOCATOR ANTENNA WITH CONDUCTIVE BOBBIN; U.S. patent application Ser. No. 14/027,027, filed Sep. 13, 2013, entitled SONDE DEVICES INCLUDING A SECTIONAL FERRITE CORE STRUCTURE; U.S. patent application Ser. No. 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 8,547,428, issued Oct. 1, 2013, entitled PIPE MAPPING SYSTEM; U.S. Pat. No. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUSLY INDICATING THE DIFFERENT LOCATIONS TO A USER; U.S. patent application Ser. No. 14/148,649, filed Jan. 6, 2014, entitled MAPPING LOCATING SYSTEMS & METHODS; U.S. Pat. No. 8,635,043, issued Jan. 21, 2014, entitled LOCATOR AND TRANSMITTER CALIBRATION SYSTEM; U.S. Pat. No. 8,717,028, issued May 6, 2014, entitled SPRING CLIPS FOR USE WITH LOCATING TRANSMITTERS; U.S. Pat. No. 8,773,133, issued Jul. 8, 2014, entitled ADAPTIVE MULTICHANNEL LOCATOR SYSTEM FOR MULTIPLE PROXIMITY DETECTION; U.S. Pat. No. 8,841,912, issued Sep. 23, 2014, entitled PRE-AMPLIFIER AND MIXER CIRCUITRY FOR A LOCATOR ANTENNA; U.S. Pat. No. 9,041,794, issued May 26, 2015, entitled PIPE MAPPING SYSTEMS AND METHODS; U.S. Pat. No. 9,057,754, issued Jun. 16, 2015, entitled ECONOMICAL MAGNETIC LOCATOR APPARATUS AND METHOD; U.S. Pat. No. 9,081,109, issued Jul. 14, 2015, entitled GROUND-TRACKING DEVICES FOR USE WITH A MAPPING LOCATOR; U.S. Pat. No. 9,082,269, issued Jul. 14, 2015, entitled HAPTIC DIRECTIONAL FEEDBACK HANDLES FOR LOCATION DEVICES; U.S. Pat. No. 9,085,007, issued Jul. 21, 2015, entitled MARKING PAINT APPLICATOR FOR PORTABLE LOCATOR; U.S. Pat. No. 9,207,350, issued Dec. 8, 2015, entitled BURIED OBJECT LOCATOR APPARATUS WITH SAFETY LIGHTING ARRAY; U.S. Pat. No. 9,341,740, issued May 17, 2016, entitled OPTICAL GROUND TRACKING APPARATUS, SYSTEMS, AND METHODS; U.S. Pat. No. 9,372,117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPARATUS, SYSTEMS, AND METHODS; U.S. Pat. No. 9,411,066, issued Aug. 9, 2016, entitled SONDES & METHODS FOR USE WITH BURIED LINE LOCATOR SYSTEMS; U.S. Pat. No. 9,411,067, issued Aug. 9, 2016, entitled GROUND-TRACKING SYSTEMS AND APPARATUS; U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 9,465,129, issued Oct. 11, 2016, entitled IMAGE-BASED MAPPING LOCATING SYSTEM; U.S. Pat. No. 9,488,747, issued Nov. 8, 2016, entitled GRADIENT ANTENNA COILS AND ARRAYS FOR USE IN LOCATING SYSTEM; U.S. Pat. No. 9,494,706, issued Nov. 15, 2016, entitled OMNI-INDUCER TRANSMITTING DEVICES AND METHODS; U.S. Pat. No. 9,523,788, issued Dec. 20, 2016, entitled MAGNETIC SENSING BURIED OBJECT LOCATOR INCLUDING A CAMERA; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. No. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. No. 9,599,740, issued Mar. 21, 2017, entitled USER INTERFACES FOR UTILITY LOCATORS; U.S. Pat. No. 9,625,602, issued Apr. 18, 2017, entitled SMART PERSONAL COMMUNICATION DEVICES AS USER INTERFACES; U.S. Pat. No. 9,632,202, issued Apr. 25, 2017, entitled ECONOMICAL MAGNETIC LOCATOR APPARATUS AND METHODS; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); United States Patent Application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. No. 9,638,824, issued May 2, 2017, entitled QUAD-GRADIENT COILS FOR USE IN LOCATING SYSTEMS; United States Patent Application, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; United States U.S. Pat. No. 9,684,090, issued Jun. 20, 2017, entitled NULLED-SIGNAL LOCATING DEVICES, SYSTEMS, AND METHODS; U.S. Pat. No. 9,696,447, issued Jul. 4, 2017, entitled BURIED OBJECT LOCATING METHODS AND APPARATUS USING MULTIPLE ELECTROMAGNETIC SIGNALS; U.S. Pat. No. 9,696,448, issued Jul. 4, 2017, entitled GROUND-TRACKING DEVICES AND METHODS FOR USE WITH A UTILITY LOCATOR; U.S. Pat. No. 9,703,002, issued Jun. 11, 2017, entitled UTILITY LOCATOR SYSTEMS & METHODS; U.S. patent application Ser. No. 15/670,845, filed Aug. 7, 2016, entitled HIGH FREQUENCY AC-POWERED DRAIN CLEANING AND INSPECTION APPARATUS & METHODS; U.S. patent application Ser. No. 15/681,250, filed Aug. 18, 2017, entitled ELECTRONIC MARKER DEVICES AND SYSTEMS; U.S. patent application Ser. No. 15/681,409, filed Aug. 20, 2017, entitled WIRELESS BURIED PIPE & CABLE LOCATING SYSTEMS; U.S. Pat. No. 9,746,572, issued Aug. 29, 2017, entitled ELECTRONIC MARKER DEVICES AND SYSTEMS; U.S. Pat. No. 9,746,573, issued Aug. 29, 2017, entitled WIRELESS BURIED PIPE AND CABLE LOCATING SYSTEMS; U.S. Pat. No. 9,784,837, issued Oct. 10, 2017, entitled OPTICAL GROUND TRACKING APPARATUS, SYSTEMS & METHODS; U.S. patent application Ser. No. 15/811,361, filed Nov. 13, 2017, entitled OPTICAL GROUND-TRACKING APPARATUS, SYSTEMS, AND METHODS; U.S. Pat. No. 9,841,503, issued Dec. 12, 2017, entitled OPTICAL GROUND-TRACKING APPARATUS, SYSTEMS, AND METHODS; U.S. patent application Ser. No. 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. patent application Ser. No. 15/866,360, filed Jan. 9, 2018, entitled TRACKED DISTANCE MEASURING DEVICES, SYSTEMS, AND METHODS; U.S. Pat. No. 9,891,337, issued Feb. 13, 2018, entitled UTILITY LOCATOR TRANSMITTER DEVICES, SYSTEMS, and METHODS WITH DOCKABLE APPARATUS; U.S. Pat. No. 9,914,157, issued March 13, 2018, entitled METHODS AND APPARATUS FOR CLEARING OBSTRUCTIONS WITH A JETTER PUSH-CABLE APPARATUS; U.S. patent application Ser. No. 15/925,643, issued Mar. 19, 2018, entitled PHASE-SYNCHRONIZED BURIED OBJECT TRANSMITTER AND LOCATOR METHODS AND APPARATUS; U.S. patent application Ser. No. 15/925,671, issued Mar. 19, 2018, entitled MULTI-FREQUENCY LOCATING SYSTEMS AND METHODS; U.S. patent application Ser. No. 15/936,250, filed Mar. 26, 208, entitled GROUND TRACKING APPARATUS, SYSTEMS, AND METHODS; U.S. Pat. No. 9,927,545, issued Mar. 27, 2018, entitled MULTI-FREQUENCY LOCATING SYSTEMS & METHODS; U.S. Pat. No. 9,928,613, issued Mar. 27, 2018, entitled GROUND TRACKING APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 9,880,309, issued Mar. 28, 2018, entitled UTILITY LOCATOR TRANSMITTER APPARATUS & METHODS; U.S. patent application Ser. No. 15/954,486, filed Apr. 16, 2018, entitled UTILITY LOCATOR APPARATUS, SYSTEMS, AND METHODS; U.S. Pat. No. 9,945,976, issued Apr. 17, 2018, entitled UTILITY LOCATOR APPARATUS, SYSTEMS, AND METHODS; U.S. Pat. No. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORHTOGONAL ANTENNAE; U.S. patent application Ser. No. 16/036,713, issued Jul. 16, 2018, entitled UTILITY LOCATOR APPARATUS AND SYSTEMS; U.S. Pat. No. 10,024,994, issued Jul. 17, 2018, entitled WEARABLE MAGNETIC FIELD UTILITY LOCATOR SYSTEM WITH SOUND FIELD GENERATION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,042,072, issued Aug. 7, 2018, entitled OMNI-INDUCER TRANSMITTING DEVICES AND METHODS; U.S. Pat. No. 10,059,504, issued Aug. 28, 2018, entitled MARKING PAINT APPLICATOR FOR USE WITH PORTABLE UTILITY LOCATOR; U.S. patent application Ser. No. 16/049,699, filed Jul. 30, 2018, entitled OMNI-INDUCER TRANSMITTING DEVICES AND METHODS; U.S. Pat. No. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. patent application Ser. No. 16/121,379, filed Sep. 4, 2018, entitled KEYED CURRENT SIGNAL UTILITY LOCATING SYSTEMS AND METHODS; U.S. patent application Ser. No. 16/125,768, filed Sep. 10, 2018, entitled BURIED OBJECT LOCATOR APPARATUS AND METHODS; U.S. Pat. No. 10,073,186, issued Sep. 11, 2018, entitled KEYED CURRENT SIGNAL UTILITY LOCATING SYSTEMS AND METHODS; U.S. patent application Ser. No. 16/133,642, issued Sep. 17, 2018, entitled MAGNETIC UTILITY LOCATOR DEVICES AND METHODS; U.S. Pat. No. 10,078,149, issued Sep. 18, 2018, entitled BURIED OBJECT LOCATORS WITH DODECAHEDRAL ANTENNA NODES; U.S. Pat. No. 10,082,591, issued Sep. 25, 2018, entitled MAGNETIC UTILITY LOCATOR DEVICES & METHODS; U.S. Pat. No. 10,082,599, issued Sep. 25, 2018, entitled MAGNETIC SENSING BURIED OBJECT LOCATOR INCLUDING A CAMERA; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/160,874, filed Oct. 15, 2018, entitled TRACKABLE DIPOLE DEVICES, METHODS, AND SYSTEMS FOR USE WITH MARKING PAINT STICKS; U.S. patent application Ser. No. 16/222,994, filed Dec. 17, 2018, entitled UTILITY LOCATORS WITH RETRACTABLE SUPPORT STRUCTURES AND APPLICATIONS THEREOF; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/241,864, filed Jan. 7, 2019, entitled TRACKED DISTANCE MEASURING DEVICES, SYSTEMS, AND METHODS; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. Pat. No. 10,247,845, issued Apr. 2, 2019, entitled UTILITY LOCATOR TRANSMITTER APPARATUS AND METHODS; U.S. patent application Ser. No. 16/382,136, filed Apr. 11, 2019, entitled GEOGRAPHIC MAP UPDATING METHODS AND SYSTEMS; U.S. Pat. No. 10,274,632, issued Apr. 20, 2019, entitled UTILITY LOCATING SYSTEMS WITH MOBILE BASE STATION; U.S. patent application Ser. No. 16/390,967, filed Apr. 22, 2019, entitled UTILITY LOCATING SYSTEMS WITH MOBILE BASE STATION; U.S. patent application Ser. No. 29/692,937, filed May 29, 2019, entitled BURIED OBJECT LOCATOR; U.S. patent application Ser. No. 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. No. 10,317,559, issued Jun. 11, 2019, entitled GROUND-TRACKING DEVICES AND METHODS FOR USE WITH A UTILITY LOCATOR; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/455,491, filed Jun. 27, 2019, entitled SELF-STANDING MULTI-LEG ATTACHMENT DEVICES FOR USE WITH UTILITY LOCATORS; U.S. Pat. No. 10,353,103, issued Jul. 16, 2019, entitled SELF-STANDING MULTI-LEG ATTACHMENT DEVICES FOR USE WITH UTILITY LOCATORS; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. Pat. No. 10,324,188, issued Oct. 9, 2019, entitled OPTICAL GROUND TRACKING APPARATUS, SYSTEMS, AND METHODS FOR USE WITH BURIED UTILITY LOCATORS; U.S. patent application Ser. No. 16/446,456, filed Jun. 19, 2019, entitled DOCKABLE TRIPODAL CAMERA CONTROL UNIT; U.S. patent application Ser. No. 16/520,248, filed Jul. 23, 2019, entitled MODULAR BATTERY PACK APPARATUS, SYSTEMS, AND METHODS; U.S. Pat. No. 10,371,305, issued Aug. 6, 2019, entitled DOCKABLE TRIPODAL CAMERA CONTROL UNIT; U.S. Pat. No. 10,490,908, issued Nov. 26, 2019, entitled DUAL ANTENNA SYSTEMS WITH VARIABLE POLARIZATION; U.S. patent application Ser. No. 16/701,085, filed Dec. 2, 2019, entitled MAP GENERATION BASED ON UTILITY LINE POSITION AND ORIENTATION ESTIMATES; U.S. Pat. No. 10,534, 105, issued Jan. 14, 2020, entitled UTILITY LOCATING TRANSMITTER APPARATUS AND METHODS; U.S. patent application Ser. No. 16/773,952, filed Jan. 27, 2020, entitled MAGNETIC FIELD CANCELING AUDIO DEVICES; U.S. patent application Ser. No. 16/780,813, filed Feb. 3, 2020, entitled RESILIENTLY DEFORMABLE MAGNETIC FIELD CORE APPARATUS AND APPLICATIONS; U.S. Pat. No. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. patent application Ser. No. 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. No. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. patent application Ser. No. 16/791,979, issued Feb. 14, 2020, entitled MARKING PAINT APPLICATOR APPARATUS; U.S. patent application Ser. No. 16/792,047, filed Feb. 14, 2020, entitled SATELLITE AND MAGNETIC FIELD SONDE APPARATUS AND METHODS; U.S. Pat. No. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,569,952, issued February 25, 2020, entitled MARKING PAINT APPLICATOR FOR USE WITH PORTABLE UTILITY LOCATOR; U.S. patent application Ser. No. 16/810,788, filed Mar. 5, 2019, entitled MAGNETICALLY RETAINED DEVICE HANDLES; U.S. patent application Ser. No. 16/827,672, filed Mar. 23, 2020, entitled DUAL ANTENNA SYSTEMS WITH VARIABLE POLARIZATION; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,608,348, issued Mar. 31, 2020, entitled DUAL ANTENNA SYSTEMS WITH VARIABLE POLARIZATION; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. patent application Ser. No. 17/235,507, filed Apr. 20, 2021, entitled UTILITY LOCATING DEVICES EMPLOYING MULTIPLE SPACED APART GNSS ANTENNAS; U.S. Provisional Patent Application 63/015,692, filed Apr. 27, 2020, entitled SPATIALLY AND PROCESSING-BASED DIVERSE REDUNDANCY FOR RTK POSITIONING; U.S. patent application Ser. No. 16/872,362, filed May 11, 2020, entitled BURIED LOCATOR SYSTEMS AND METHODS; U.S. patent application Ser. No. 16/882,719, filed May 25, 2020, entitled UTILITY LOCATING SYSTEMS, DEVICES, AND METHODS USING RADIO BROADCAST SIGNALS; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,677,820, issued Jun. 9, 2020, entitled BURIED LOCATOR SYSTEMS AND METHODS; U.S. patent application Ser. No. 16/902,245, filed Jun. 15, 2020, entitled LOCATING DEVICES, SYSTEMS, AND METHODS USING FREQUENCY SUITES FOR UTILITY DETECTION; U.S. patent application Ser. No. 16/902,249, filed Jun. 15, 2020, entitled USER INTERFACES FOR UTILITY LOCATORS; U.S. Pat. No. 10,690,795, issued Jun. 23, 2020, entitled LOCATING DEVICES, SYSTEMS, AND METHODS USING FREQUENCY SUITES FOR UTILITY DETECTION; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,690,796, issued Jun. 23, 2020, entitled USER INTERFACES FOR UTILITY LOCATORS; U.S. patent application Ser. No. 16/921,775, filed Jul. 6, 2020, entitled AUTO-TUNING CIRCUIT APPARATUS AND METHODS; U.S. Provisional Patent Application 63/055,278, filed Jul. 22, 2020, entitled VEHICLE-BASED UTILITY LOCATING USING PRINCIPAL COMPONENTS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTILITY LOCATOR INCLUDING A CAMERA; U.S. patent application Ser. No. 16/995,793, filed Aug. 17, 2020, entitled UTILITY LOCATOR APPARATUS AND METHODS; U.S. Pat. No. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; U.S. Pat. No. 10,761,233, issued Sep. 1, 2020, entitled SONDES AND METHODS FOR USE WITH BURIED LINE LOCATOR SYSTEMS; U.S. Pat. No. 10,761,239, issued Sep. 1, 2020, entitled MAGNETIC SENSING BURIED UTILITY LOCATOR INCLUDING A CAMERA; U.S. patent application Ser. No. 17/013,831, filed Sep. 7, 2020, entitled MULTIFUNCTION BURIED UTILITY LOCATING CLIPS; U.S. Pat. No. 10,777,919, issued Sep. 15, 2020, entitled MULTIFUNCTION BURIED UTILITY LOCATING CLIPS; U.S. patent application Ser. No. 17/020,487, filed Sep. 14, 2020, entitled ANTENNA SYSTEMS FOR CIRCULARLY POLARIZED RADIO SIGNALS; U.S. patent application Ser. No. 17/068,156, filed Oct. 12, 2020, entitled DUAL SENSED LOCATING SYSTEMS AND METHODS; U.S. Provisional Patent Application 63/091,67, filed Oct. 14, 2020, entitled ELECTRONIC MARKER-BASED NAVIGATION SYSTEMS AND METHODS FOR USE IN GNSS-DEPRIVED ENVIRONMENTS; U.S. Pat. No. 10,809,408, issued Oct. 20, 2020, entitled DUAL SENSED LOCATING SYSTEMS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 10,859,727, issued Dec. 8, 2020, entitled ELECTRONIC MARKER DEVICES AND SYSTEMS; U.S. Pat. No. 10,908,311, issued Feb. 2, 2021, entitled SELF-STANDING MULTI-LEG ATTACHMENT DEVICES FOR USE WITH UTILITY LOCATORS; U.S. Pat. No. 10,928,538, issued Feb. 23, 2021, entitled KEYED CURRENT SIGNAL LOCATING SYSTEMS AND METHODS; U.S. Pat. No. 10,935,686, issued Mar. 2, 2021, entitled UTILITY LOCATING SYSTEM WITH MOBILE BASE STATION; and U.S. Pat. No. 10,955,583, issued Mar. 23, 2021, entitled BORING INSPECTION SYSTEMS AND METHODS; U.S. Pat. No. 9,927,368, issued Mar. 27, 2021, entitled SELF-LEVELING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. patent application Ser. No. 17/528,956, filed Nov. 17, 2021, entitled VIDEO INSPECTION SYSTEM, APPARATUS, AND METHODS WITH RELAY MODULES AND CONNECTION PORT; U.S. patent application Ser. No. 17/541,057, filed Dec. 2, 2021, entitled COLOR-INDEPENDENT MARKER DEVICE APPARATUS, METHODS, AND SYSTEMS; U.S. patent application Ser. No. 17/541,057, filed Dec. 2, 2021, entitled VIDEO INSPECTION SYSTEM, APPARATUS, AND METHODS WITH RELAY MODULES AND CONNECTION PORTCOLOR-INDEPENDENT MARKER DEVICE APPARATUS, METHODS, AND SYSTEMS; U.S. Pat. No. 11,193,767, issued Dec. 7, 2021, entitled SMART PAINT STICK DEVICES AND METHODS; U.S. Pat. No. 11,199,510, issued Dec. 14, 2021, entitled PIPE INSPECTION AND CLEANING APPARATUS AND SYSTEMS; U.S. Provisional Patent Application 63/293,828, filed Dec. 26, 2021, entitled MODULAR BATTERY SYSTEMS INCLUDING INTERCHANGEABLE BATTERY INTERFACE APPARATUS; U.S. Pat. No. 11,209,115, issued Dec. 28, 2021, entitled PIPE INSPECTION AND/OR MAPPING CAMERA HEADS, SYSTEMS, AND METHODS; U.S. patent application Ser. No. 17/563,049, filed Dec. 28, 2021, entitled SONDE DEVICES WITH A SECTIONAL FERRITE CORE; U.S. Provisional Patent Application 63/306,088, filed Feb. 2, 2022, entitled UTILITY LOCATING SYSTEMS AND METHODS WITH FILTER TUNING FOR POWER GRID FLUCTUATIONS; U.S. patent application Ser. No. 17/687,538, filed Mar. 4, 2022, entitled ANTENNAS, MULTI-ANTENNA APPARATUS, AND ANTENNA HOUSINGS; U.S. Pat. No. 11,280,934, issued Mar. 22, 2022, entitled ELECTROMAGNETIC MARKER DEVICES FOR BURIED OR HIDDEN USE; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; MODULAR BATTERY SYSTEMS INCLUDING INTERCHANGEABLE BATTERY INTERFACE APPARATUS; U.S. patent application Ser. No. 18/162,663, filed Jan. 31, 2023, entitled UTILITY LOCATING SYSTEMS AND METHODS WITH FILTER TUNING FOR POWER GRID FLUCTUATIONS; U.S. Provisional Patent Application 63/485,905, filed Feb. 18, 2023, entitled SYSTEMS AND METHODS FOR INSPECTION ANIMATION; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,613, issued Mar. 28, 2023, entitled DOCKABLE CAMERA CABLE DRUM-REEL AND CCU SYSTEM; U.S. Pat. No. 11,649,917, issued May 16, 2023, entitled INTEGRATED FLEX-SHAFT CAMERA SYSTEM WITH HAND CONTROL; U.S. Pat. No. 11,665,321, issued May 30, 2023, entitled PIPE INSPECTION SYSTEM WITH REPLACEABLE CABLE STORAGE DRUM; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,686,878, issued Jun. 27, 2023, entitled ELECTRONIC MARKER DEVICES FOR BURIED OR HIDDEN USE; U.S. Provisional Patent Application 63/524,698, filed Jul. 2, 2023, entitled FILTERING METHODS AND ASSOCIATED UTILITY LOCATOR DEVICES FOR LOCATING AND MAPPING BURIED UTILITY LINES; U.S. Provisional Patent Application 63/514,090, filed Jul. 17, 2023, entitled SMARTPHONE MAPPING APPARATUS FOR ASSET TAGGING AS USED WITH UTILITY LOCATOR DEVICES; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. Pat. No. 11,719,646, issued Aug. 8, 2023, entitled PIPE MAPPING SYSTEMS AND METHODS; U.S. Pat. No. 11,719,846, issued Aug. 8, 2023, entitled BURIED UTILITY LOCATING SYSTEMS WITH WIRELESS DATA COMMUNICATION INCLUDING DETERMINATION OF CROSS COUPLING TO ADJACENT UTILITIES; U.S. patent application Ser. No. 18/233,285, filed Aug. 11, 2023, entitled BURIED OBJECT LOCATOR; U.S. patent application Ser. No. 18/236,786, filed Aug. 22, 2023, entitled MAGNETIC UTILITY LOCATOR DEVICES AND METHODS; U.S. Pat. No. 11,747,505, issued Sep. 5, 2023, entitled MAGNETIC UTILITY LOCATOR DEVICES AND METHODS; U.S. patent application Ser. No. 18/368,510, filed Sep. 14, 2023, entitled MULTIFUNCTION BURIED UTILITY LOCATING CLIPS; U.S. patent application Ser. No. 18/365,203, filed Sep. 14, 2023, entitled SYSTEMS AND METHODS FOR ELECTRONICALLY MARKING, LOCATING AND VIRTUALLY DISPLAYING BURIED UTILITIES; U.S. Pat. No. 11,768,308, issued Sep. 26, 2023, entitled SYSTEMS AND METHODS FOR ELECTRONICALLY MARKING, LOCATING AND VIRTUALLY DISPLAYING BURIED UTILITIES; U.S. Pat. No. 11,769,956, issued Sep. 26, 2023, entitled MULTIFUNCTION BURIED UTILITY LOCATING CLIPS; U.S. Pat. No. 11,782,179, issued Oct. 10, 2023, entitled BURIED OBJECT LOCATOR WITH DODECAHEDRAL ANTENNA CONFIGURATION APPARATUS AND METHODS; U.S. Pat. No. 11,789,093, issued Oct. 17, 2023, entitled THREE-AXIS MEASUREMENT MODULES AND SENSING METHODS; U.S. application Ser. No. 18/490,763, filed Oct. 20, 2023, entitled LINKED CABLE-HANDLING AND CABLE-STORAGE DRUM DEVICES AND SYSTEMS FOR COORDINATED MOVEMENT OF PUSH-CABLE; U.S. Pat. No. 11,796,707, issued Oct. 24, 2023, entitled USER INTERFACES FOR UTILITY LOCATORS; U.S. patent application Ser. No. 18/544,042, filed Dec. 18, 2023, entitled SYSTEMS, APPARATUS, AND METHODS FOR DOCUMENTING UTILITY POTHOLES AND ASSOCIATED UTILITY LINES; U.S. Pat. No. 11,876,283, issued Jan. 16, 2024, entitled COMBINED SATELLITE NAVIGATION AND RADIO TRANSCEIVER ANTENNA DEVICES; U.S. Pat. No. 11,894,707, issued Feb. 6, 2024, entitled RECHARGEABLE BATTERY PACK ONBOARD CHARGE STATE INDICATION METHODS AND APPARATUS; U.S. Pat. No. 11,909,104, issued Feb. 20, 2024, entitled ANTENNAS, MULTI-ANTENNA APPARATUS, AND ANTENNA HOUSINGS; U.S. Provisional Patent Application 63/558,098, filed Feb. 26, 2024, entitled SYSTEMS, DEVICES, AND METHODS FOR DOCUMENTING GROUND ASSETS AND ASSOCIATED UTILITY LINES; U.S. Pat. No. 11,921,225, issued Mar. 5, 2024, entitled ANTENNA SYSTEMS FOR CIRCULARLY POLARIZED RADIO SIGNALS; U.S. patent application Ser. No. 18/611,449, filed Mar. 20, 2024entitled VIDEO INSPECTION AND CAMERA HEAD TRACKING SYSTEMS AND METHODS; U.S. Pat. No. 11,953,643, issued Apr. 9, 2024, entitled MAP GENERATION BASED ON UTILITY LINE POSITION AND ORIENTATION ESTIMATES; U.S. Pat. No. 11,962,943, issued Apr. 16, 2024, entitled INSPECTION CAMERA DEVICES AND METHODS; U.S. Provisional Patent 63/643,915, filed May 7, 2024, entitled SYSTEMS AND METHODS FOR LOCATING AND MAPPING BURIED UTILITY OBJECTS USING ARTIFICIAL INTELLIGENCE WITH LOCAL OR REMOTE PROCESSING; U.S. Pat. No. 11,988,951, issued May 21, 2024, entitled MULTI-DIELECTRIC COAXIAL PUSH-CABLES AND ASSOCIATED APPARATUS; U.S. Provisional Patent 63/659,722, filed Jun. 13, 2024, entitled VEHICLE-MOUNTING DEVICES AND METHODS FOR USE IN VEHICLE-BASED LOCATING SYSTEMS; U.S. application Ser. No. 18/747,912, filed Jun. 19, 2024, entitled INNER DRUM MODULE WITH PUSH-CABLE INTERFACE FOR PIPE INSPECTION; U.S. application Ser. No. 18/758,937, filed Jun. 28, 2024, entitled FILTERING METHODS AND ASSOCIATED UTILITY LOCATOR DEVICES FOR LOCATING AND MAPPING BURIED UTILITY LINES; U.S. patent application Ser. No. 18/774,758, filed Jul. 16, 2024, entitled SMARTPHONE MOUNTING APPARATUS AND IMAGING METHODS FOR ASSET TAGGING AND UTILITY MAPPING AS USED WITH UTILITY LOCATING DEVICES; U.S. Provisional Patent 63/674,749, issued Jul. 23, 2024, entitled PIPE MAPPING FOR FEATURE AND ASSET RECOGNITION USING ARTIFICIAL INTELLIGENCE; U.S. Provisional Patent 63/692,642, issued Sep. 9, 2024, entitled ELECTRONIC MODULES AND ASSOCIATED SYSTEMS; U.S. Provisional Patent 63/694,102, issued Sep. 12, 2024, entitled METHODS AND APPARATUS FOR BATTERY SWAPPING IN UTILITY LOCATOR DEVICES AND OTHER COMPLEX BOOTABLE ELECTRONIC DEVICES; U.S. Provisional Patent 63/719,026, issued Nov. 11, 2024, entitled PUSH-CABLE WITH OFFSET JACKET EXTRUSION; U.S. Provisional Patent 63/726,858, issued Dec. 2, 2024, entitled DIGITAL SELF-LEVELING PIPE INSPECTION CAMERA SYSTEMS AND METHODS WITH AUTOMATIC MAGNIFICATION; U.S. patent application Ser. No. 19/018,842, issued Jan. 13, 2025, entitled ACCESSIBLE DRUM-REEL FRAME FOR PIPE INSPECTION CAMERA SYSTEM; U.S. Provisional Patent Application 63/761,029, filed Feb. 20, 2025, entitled UTILITY LOCATING SYSTEMS, DEVICES, AND METHODS EMPLOYING SPATIAL AUDIO; U.S. patent application Ser. No. 19/059,288, filed Feb. 21, 2025, entitled SYSTEMS, DEVICES, AND METHODS FOR DOCUMENTING GROUND ASSETS AND ASSOCIATED UTILITY LINES; U.S. Provisional Patent Application 63/770,287, filed Mar. 11, 2025, entitled WORLD FRAME/LOCAL FRAME MAPPING AND RE-MAPPING IN A UTILITY LOCATION SYSTEM; and U.S. Pat. No. 12,253,382, issued Mar. 18, 2025, entitled VEHICLE-BASED UTILITY LOCATING USING PRINCIPAL COMPONENTS. The content of each of the above-described patents and applications is incorporated by reference herein in its entirety. The above applications may be collectively denoted herein as the “co-assigned applications” or “incorporated applications.”

Articles hereby incorporated by reference herein in their entirety include https://www.section.io/engineering-education/understanding-pattern-recognition-in-machine-learning/#: ˜:text=Pattern%20recognition%20is%20the%20use%20of%20machine%20learning% 20algorithms%20to,to%20train%20pattern%20recognition%20systems; https://en.wikipedia.org/wiki/Deep_learning; https://www.nature.com/articles/d41586-020-03348-4; https://deepmind.com/research/case-studies/alphago-the-story-so-far; and https://readwrite.com/2019/11/02/machine-learning-for-translation-whats-the-state-of-the-language-art/; http://sciencewise.info/media/pdf/1507.08818v1.pdf

### BRIEF DESCRIPTION OF THE DRAWINGS

FIG. 1 is an illustration of different methods for collecting multifrequency electromagnetic data from buried objects associated with utilities or communication systems, as known in the prior art.

FIG. 2 is an illustration of an embodiment of a method of using Deep Learning/artificial intelligence to recognize patterns and make predictions related to underground utilities, in accordance with certain aspects of the present invention.

FIG. 3 is an illustration of an embodiment of a system, including a service worker using a portable locator and a sonde to collect electromagnetic frequency data or other data from underground or buried assets, in accordance with certain aspects of the present invention.

FIG. 4 is an illustration of an embodiment of a system, including a vehicle equipped with a locator to collect electromagnetic frequency data or other data from underground or buried assets, in accordance with certain aspects of the present invention.

FIG. 5 is an illustration of an embodiment of a method of providing training data to a neural network to use Deep Learning/artificial intelligence to recognize patterns and make predictions related to underground utilities, in accordance with certain aspects of the present invention.

FIG. 6 is an illustration of an embodiment of a chart showing various types of collected and other data as Training Data for Deep Learning in a Neural Network that uses Artificial Intelligence (AI), in accordance with certain aspects of the present invention.

FIG. 7 is an illustration of an embodiment of a system of using a remote device with a utility locator to access additional conventional or AI processing resources available on the remote device and/or in the Cloud.

FIG. 8 is an illustration of an embodiment of a system using a remote device with a pipe inspection camera and a cable drum-reel to access additional conventional or AI processing resources available on the remote device and/or in the Cloud, in accordance with certain aspects of the present invention.

FIG. 9 is an illustration of an embodiment is an illustration of an embodiment of a system of a remote device with a utility locator and a vehicle to access additional conventional or AI processing resources available on the remote device, in accordance with certain aspects of the present invention.

FIG. 10 is an illustration of an embodiment of a method of using a remote device with a utility locator to access additional conventional or AI processing resources available on the remote device, in accordance with certain aspects of the present invention.

FIG. 11 is an illustration of an embodiment of a method of using a remote device with a utility locator to access additional conventional or AI processing resources available on the remote device with a feedback loop for improving a prediction model, in accordance with certain aspects of the present invention.

FIG. 12 is an illustration of an embodiment is an illustration of an embodiment of a method of using a remote device with a utility locator to access additional conventional or AI processing resources available on the remote device, in accordance with certain aspects of the present invention.

FIG. 13 is an illustration of an embodiment of a method of using a remote device with a utility locator to access additional conventional or AI processing resources available on the remote device and/or in the Cloud, in accordance with certain aspects of the present invention.

FIG. 14 is an illustration of an embodiment of a method of using a remote device with a utility locator to access additional conventional or AI processing resources available in the Cloud, in accordance with certain aspects of the present invention.

### DETAILED DESCRIPTION

It is noted that as used herein, the term “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Example Embodiments

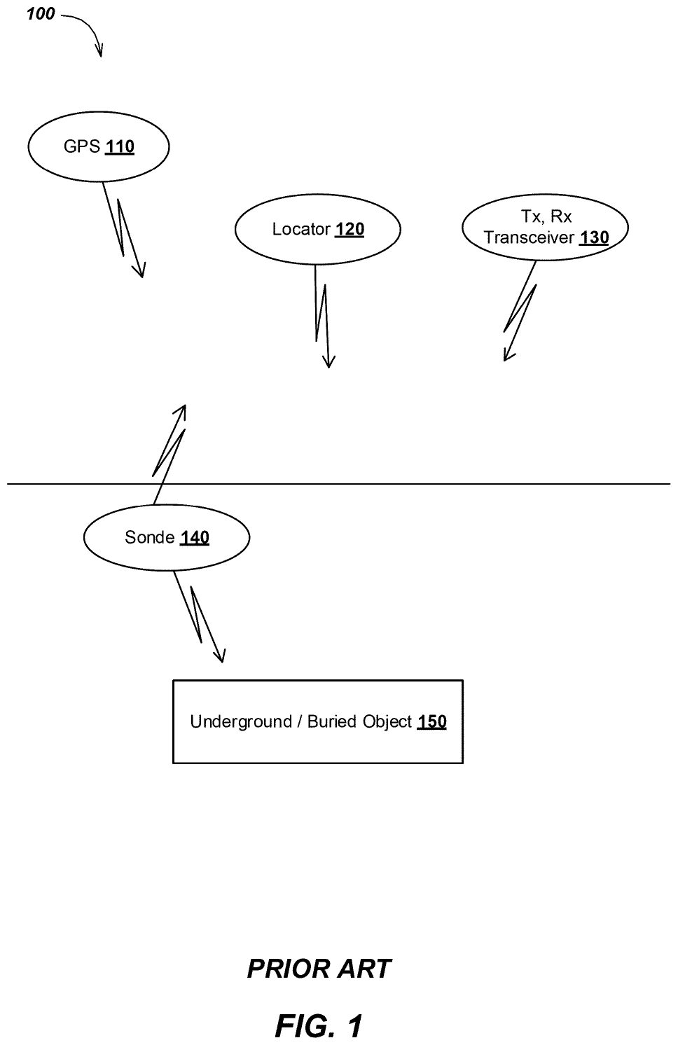

FIG. 1 illustrates details of an exemplary embodiment of different methods 100 for collecting multifrequency electromagnetic data from buried objects associated with utilities 150. Methods 100 may include collecting data from various apparatus with the ability to receive, measure, or sense single or multifrequency electromagnetic data from under or above ground sources. The various apparatus may include one or more of the following: GPS or other satellite systems 110, utility or other locator systems 120, equipment with one or more transmitters, receivers, or transceivers 130, sonde equipment 140, and many other types of utility sensing equipment well known by those skilled in the art.

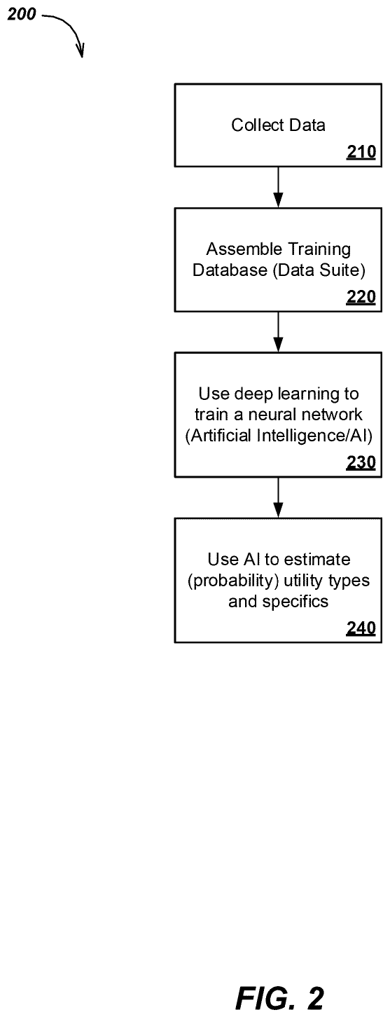

FIG. 2 illustrates details of an exemplary method 200 of using Deep Learning/artificial intelligence to recognize patterns and make predictions related to underground utilities. The method starts at block 210 collecting data and proceeds to block 220 where a Training Data Base, also known as a Data Suite or Training Data Suite, is assembled. The method then proceeds to block 230 where Deep Learning is used to train a neural network using Artificial Intelligence. Finally, the method proceeds to block 240 where AI estimates the probability that underground or buried objects or assets are specific types of equipment or utilities and other specifics including but not limited to current and/or voltage data, even and odd harmonics data, active and/or passive signal data, and spatial relationship data.

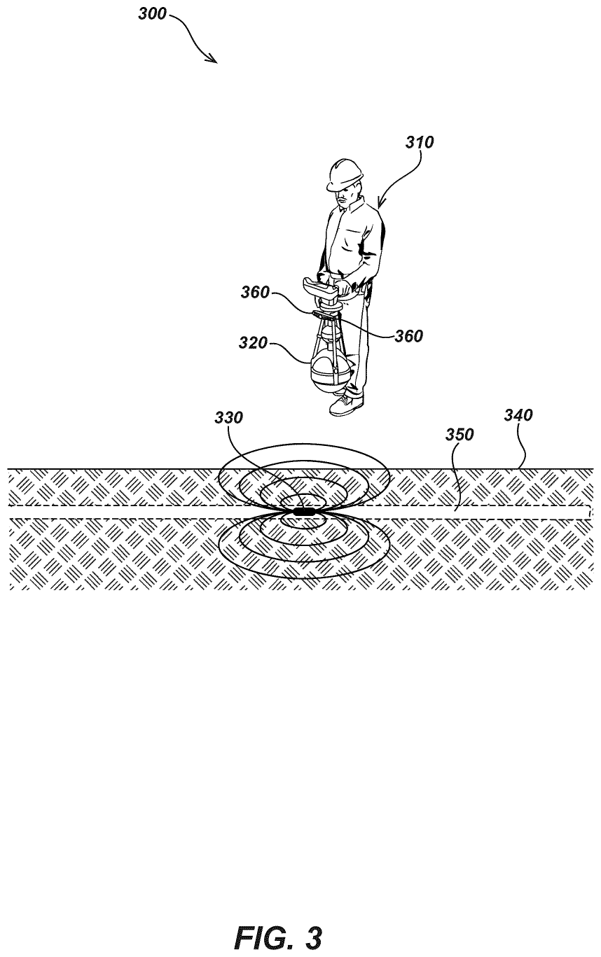

FIG. 3 illustrates details of an exemplary embodiment 300 of a system including a service worker 310 using a portable locator 320, and a sonde 330 located underground 340 to collect single or multifrequency electromagnetic data from an underground or buried utility asset 350.

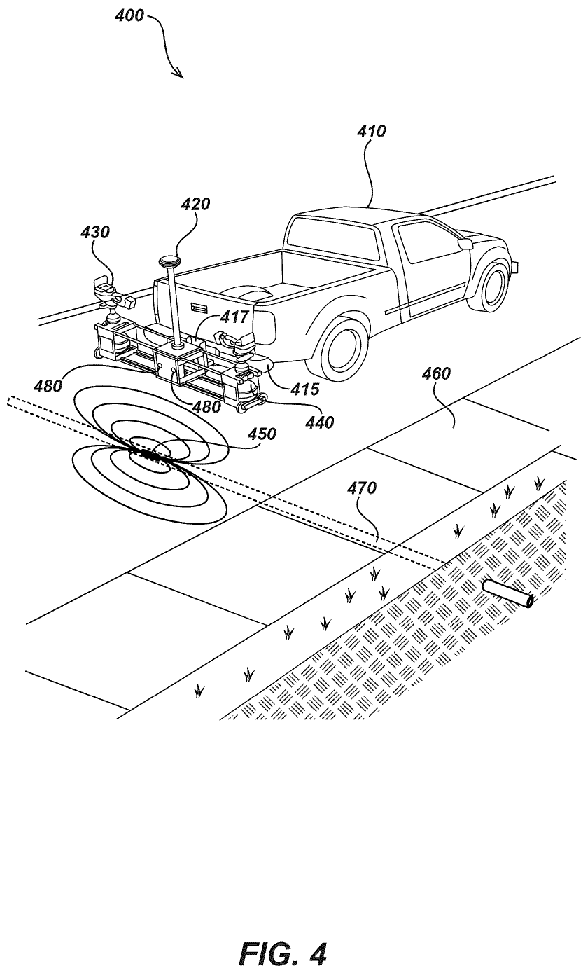

FIG. 4 illustrates details of an exemplary embodiment 400 of a system including a vehicle 410 equipped with an GNSS antenna 420, a locator 430, a dodecahedron antenna 440, and a sonde 450 located underground 460, used to collect single or multifrequency electromagnetic data from an underground or buried utility asset 470.

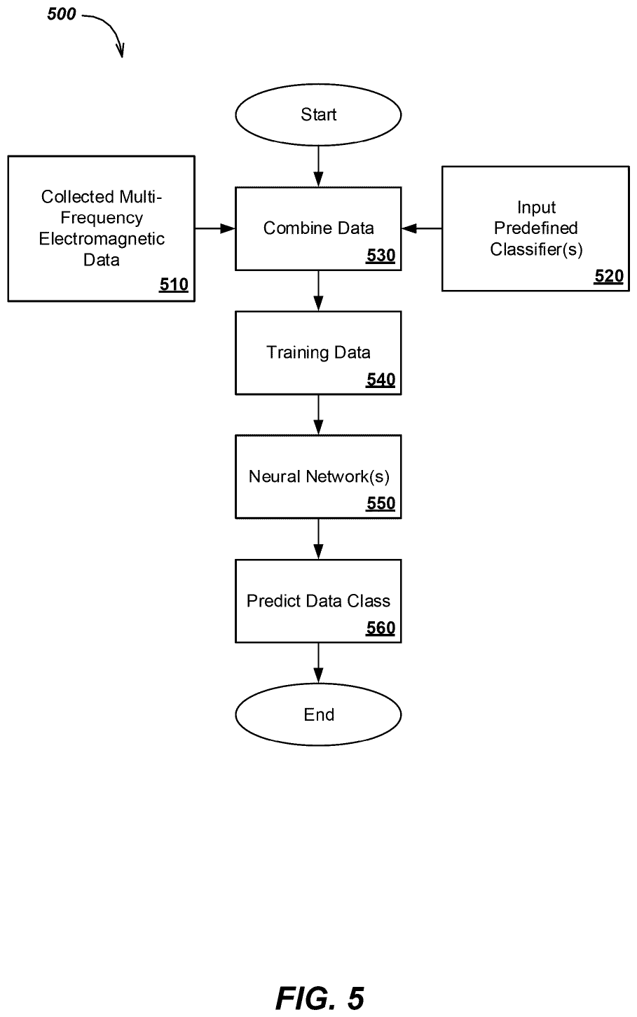

FIG. 5 illustrates details of an exemplary embodiment 500 of a method of providing training data to a neural network to use Deep Learning/artificial intelligence to recognize patterns and make predictions related to underground utilities. Multifrequency Electromagnetic Data 510 may be collected from multiple sources, any Predefined Classifier(s) 520 may be inputted or entered by a user, and both may be combined in block 530. Other data such as image data, harmonics data, etc. may also be combined in block 530. The Combined data is also known as a Data Suite. Data combined at 530 becomes available to be used as Training Data, also known as a Training Data Suite, at block 540. The Training Data 540 is then provided to one or more Neural Networks 550 which use Deep Learning to predict one or more data classes 560 for the underground or buried assets related to utility and communication systems. Artificial Intelligence (AI) is used to provide a probability that specific assets have specific characteristics, have relationships between other assets, and fall into one or more classification or categories by using the training data to recognize patterns.

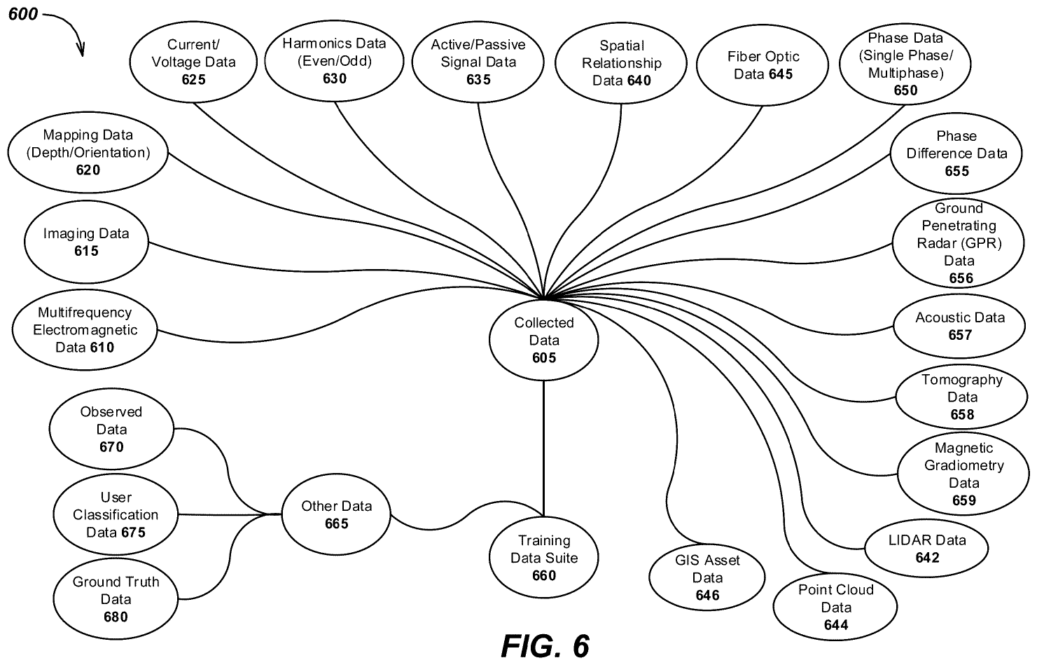

FIG. 6 illustrates details of an exemplary embodiment 600 of a chart showing various types of collected and other data as Training Data for Deep Learning in a Neural Network that uses Artificial Intelligence (AI). Collected Data 605 may include Multifrequency Electromagnetic Data 610, Imaging Data 615, Mapping Data 620 which may include Depth and/or Orientation Data, Current and/or Voltage Data 625, Harmonics Data 630 including Even and/or Odd Harmonics Data, Active and/or Passive Signal Data 635, Spatial Relationship Data 640, Fiber Optic Data 645, Phase Data 650 which may include Single Phase or Multiphase Data, Phase Difference Data 655, Ground Penetrating Radar Data (GPR) 656, Acoustic Data 657, Tomography Data 658, Magnetic Gradiometry Data 659, LIDAR data 642, Point Cloud data 644, and GIS Asset Data 646. It is contemplated that additional types of Collected Data 605 related to utilities and communication systems could also be used, and would be apparent to those skilled in the art. Training Suite Data 660, which may include Collected Data 605, may also include Other Data 665. Other Data 665 may include one or more of the following: Observed Data 670, User Classification Data 675, and Ground Truth Data 680. It is contemplated that additional types of Other Data 665 related to utilities and communication systems could also be used, and would be apparent to those skilled in the art. Some examples of such data are paint marks including previous paint on the ground, pipeline markers, overhead utilities/powerlines, construction techniques uses, e.g. trenchfill (conductivity and magnetic permeability), local ground conductivity, type of equipment in operation on the grid. For instance, equipment could include horizontal drilling equipment that generally runs generally straight between a drill “in” pit and a drill “out pit. There are of course innumerable types of equipment that could be operating on the grid at any given time, these are well known in the art. Collected can include data collected walking and/or by vehicle including air collected data such as data collected by a drone. Collected data can be used separately or combined from multiple sources.

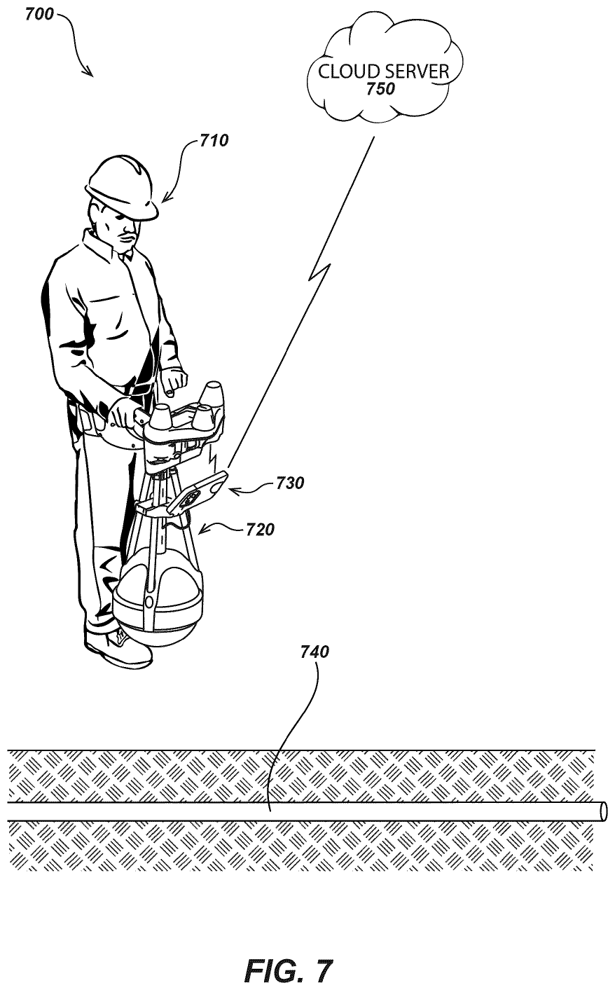

FIG. 7 illustrates details of an exemplary embodiment 700 of a system including a service worker 710 using a portable utility locator 720 to collect single or multifrequency electromagnetic data for an underground or buried utility 740. A smartphone or other remote device 730 may be provided to wirelessly communicate data between the locator 720 and itself. Optionally, the smartphone/remote device may also communicate with the Cloud 750 (a Cloud Server).

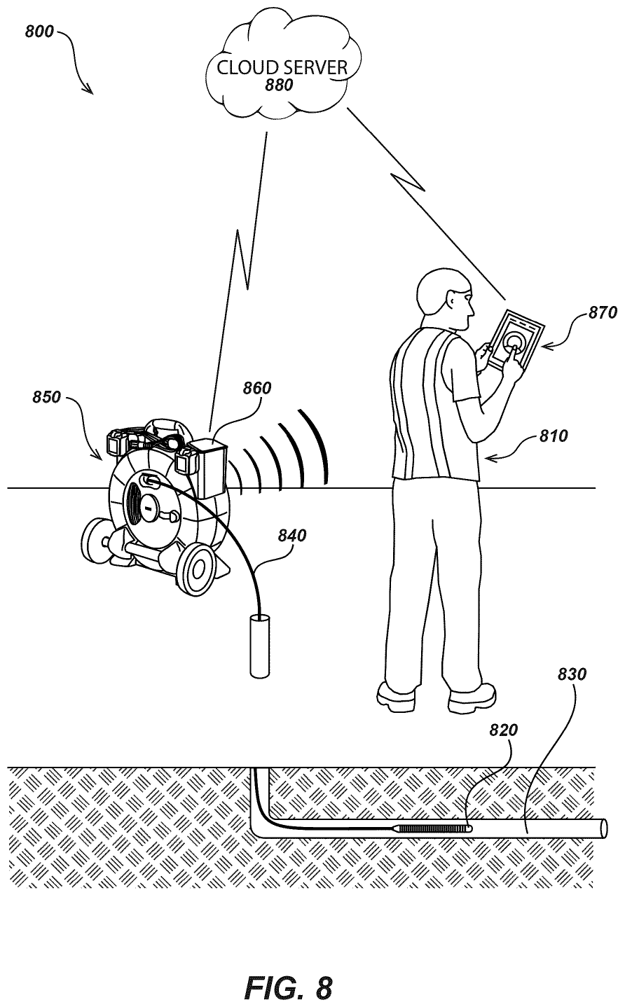

FIG. 8 illustrates details of an exemplary embodiment 800 of a system including a service worker 810 using a pipe inspection camera 820 to inspect an underground or buried pipe 830. The camera 820 is attached to a cable 840 which is stored and/or fed from a cable drum-reel 850. A wireless communication module 860 is provided to facilitate communication between the cable drum-reel 860 and a smart phone or other remote device 870. Optionally, the smartphone/remote device may also communicate with the Cloud 880 (Cloud Server).

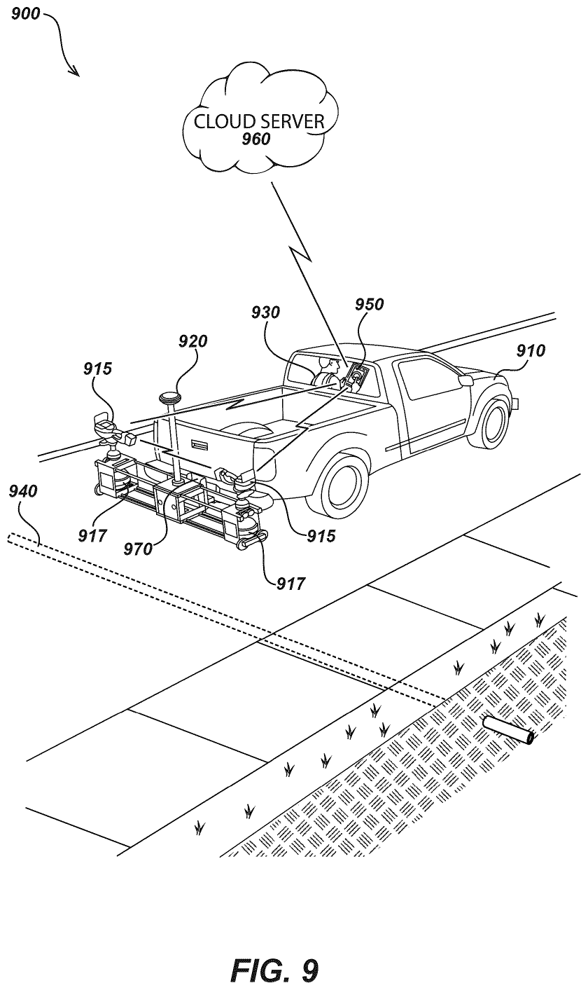

FIG. 9 illustrates details of an exemplary embodiment 900 of a system including a vehicle 910 equipped with one or more utility locators 915 each with one or more EM antennas 917. The locators 720 include one or more GNSS antennas 920. Optionally, one or more GNSS antennas 920 may be mounted on or with one or more locators 915, mounted to the hitch 970, or vehicle mounted 910. A user 930 may drive or park the vehicle to enable the the locators 915 to collect multifrequency electromagnetic data from an underground or buried utility 940. Collected data may be communicated wirelessly to a smart phone or other remote device 950. Optionally, the smartphone/remote device may also communicate with the Cloud 960 (a Cloud Server).

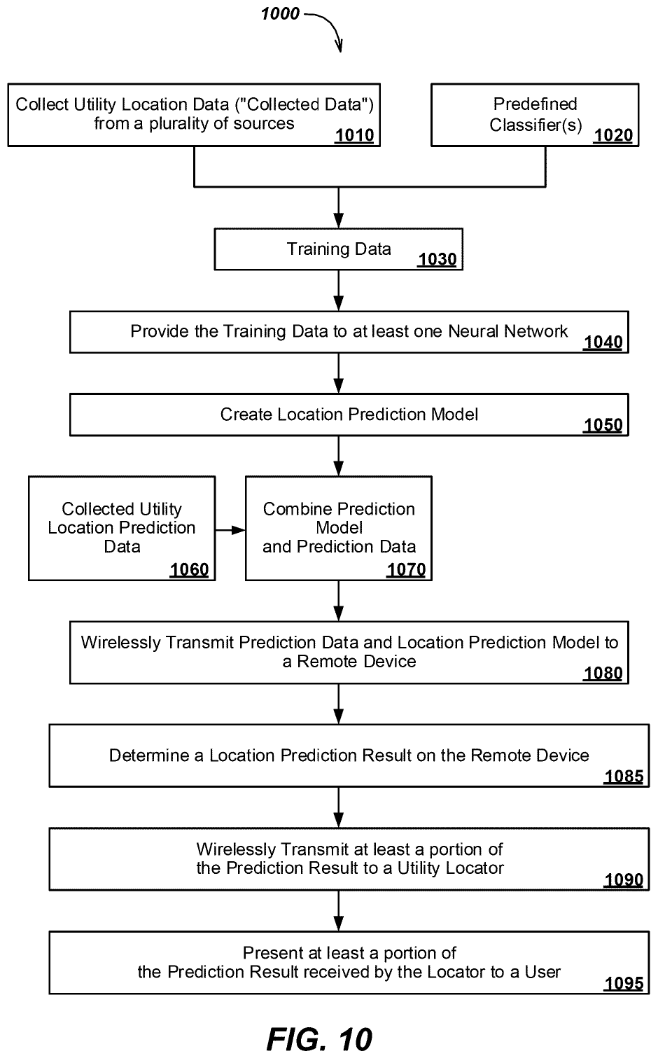

FIG. 10 illustrates details of an exemplary a method 1000 of using a remote device with a utility locator to access additional conventional or AI processing resources available on the remote device. The method starts at block 1010 collecting Utility Location Data “Collected Data” from a plurality of sources, and optionally providing Predefined Classifiers 1020, both of which are used as input for Training Data 1030. Next at block 1040, the Training Data is provided to at least one Neural Network to create a Location Prediction Model 1050. The Prediction Model 1050 and collected Utility Location Prediction Data 1060 (i.e. data to be used to make an AI prediction related underground or buried utilities) are then combined at block 1070. Next at block 1080, Prediction Data 1060 and the Location Prediction Model 1070 are wirelessly transmitted to a Remote Device. It should be noted that combining the Location Prediction Model 1050 and Location Prediction Data 1060 may mean they are combined into a single stream of data and transmitting the stream wirelessly, or transmitting the Model 1050 and Prediction Data separately at the same time, or at different times to a Remote Device 1080. Next, a Location Prediction Result is determined on the Remote Device at block 1085. Next, at least a portion of the Location Prediction Result from block 1085 is wirelessly transmitted back to the Utility Locator 1090 where at least a portion of the of the previously transmitted Location Prediction Result received by the Locator is presented to a user 1095, e.g. rendered on a display, provided as audio or tactile output, and other well known ways of providing data to a user. Displayed data may be provided in many forms including mapped data, alpha-numeric data, etc. Any previously mentioned data may be stored permanently or temporarily at any stage on the Utility Locator, on the Remote Device, or on any suitable external storage medium.

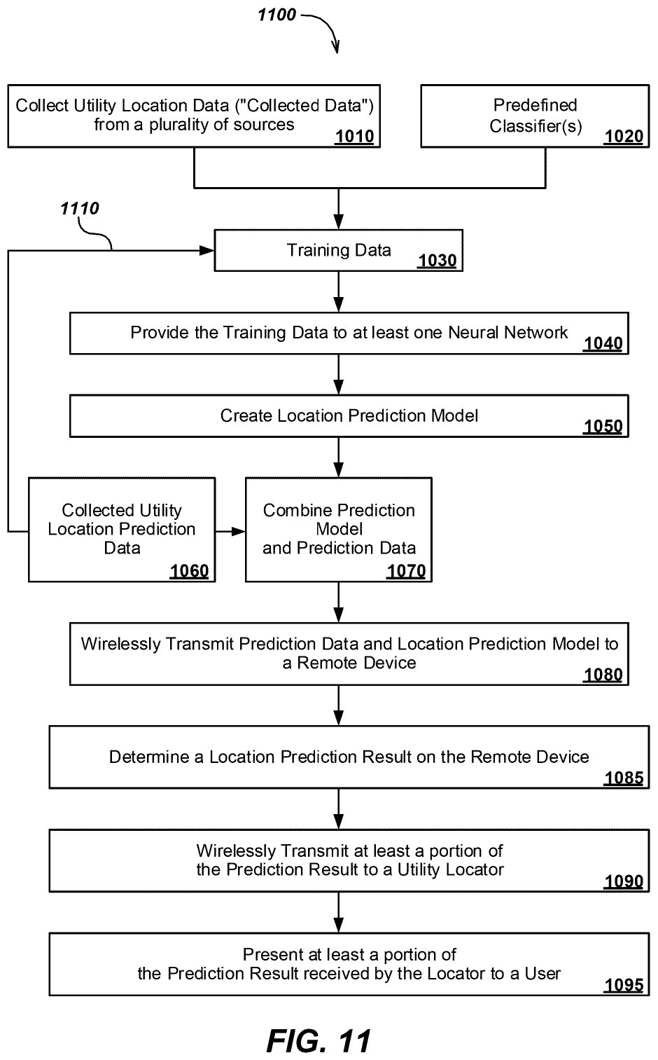

FIG. 11 illustrates details of an exemplary method 1100 of a remote device with a utility locator to access additional conventional or AI processing resources available on the remote device (refer back to FIG. 10 description) with a feedback loop 1110 for improving the Prediction Model. At block 1070 Collected Utility Location Prediction Data from block 1060 is combined with the created Prediction Model from block 1050. The Utility Location Prediction data 1060 may also be used as feedback 1110, i.e. Training Data 1030 to be used as input to at least one Neural Network 1040 to create an updated Location Prediction Model at block 1050. This may be a one time process or an iterative process, thereby constantly improving the Location Prediction Model.

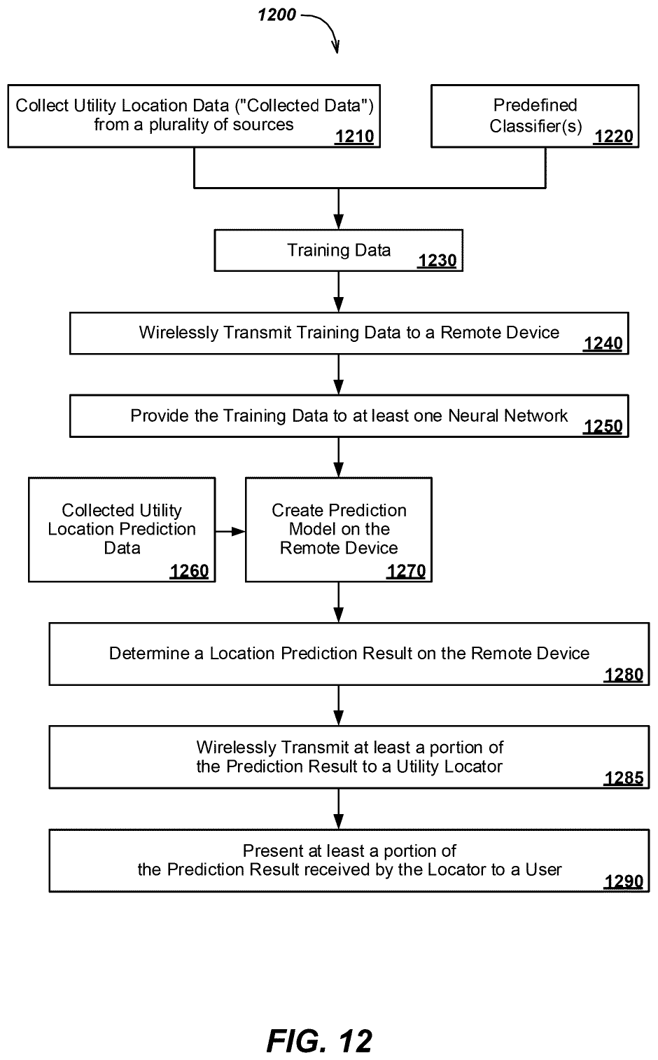

FIG. 12 illustrates details of an exemplary method 1200 of using a remote device with a utility locator to access additional conventional or AI processing resources available on the remote device. The method starts at block 1210 collecting Utility Location Data “Collected Data” from a plurality of sources, and optionally providing Predefined Classifiers 1220, both of which are used as input for Training Data 1230. Next at block 1240, the Training Data is wirelessly transmitted to a Remote Device, and then the Training Data is provided to at least one Neural

Network 1250 to create a Prediction Model on the Remote Device 1270. Collected Utility Location Data 1260 is then input into the Prediction Model 1270 to determine a Location Prediction Result on the Remote Device 1280. Next, at least a portion of the Location Prediction Result from block 1280 is wirelessly transmitted back to the Utility Locator 1285, and where at least a portion of the of the previously transmitted Location Prediction Result received by the Locator is presented to a user 1095, e.g. rendered on a display, provided as audio or tactile output, and other well known ways of providing data to a user and where at least a portion of the of the previously transmitted Location Prediction Result received by the Locator is presented to a user 1290, e.g. rendered on a display, provided as audio or tactile output, and other well known ways of providing data to a user.

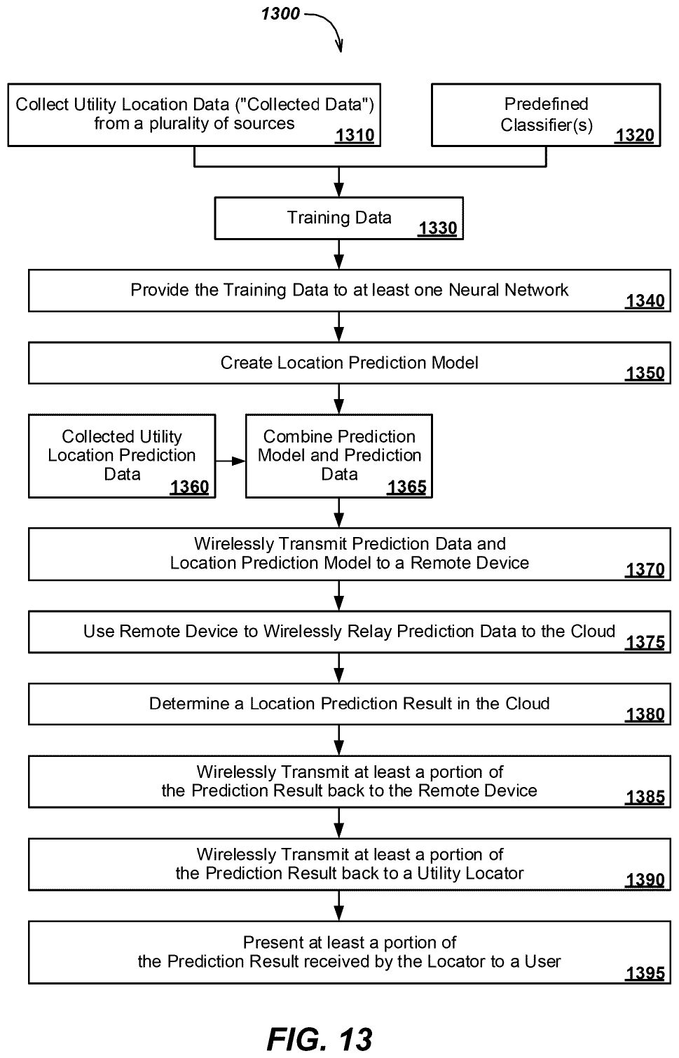

FIG. 13 illustrates details of an exemplary a method 1300 of using a remote device with a utility locator to access additional conventional or AI processing resources available in the Cloud. The method starts at block 1310 collecting Utility Location Data “Collected Data” from a plurality of sources, and optionally providing Predefined Classifiers 1320, both of which are used as input for Training Data 1330. Next at block 1340, the Training Data is provided to at least one Neural Network located on or at a Utility Locator or a Utility Inspection Camera Cable Drum-reel to create a Location Prediction Model 1340. The Prediction Model 1350 and collected Utility Location Prediction Data 1360 are then combined at block 1365. It should be noted that combining the Location Prediction Model 1050 and Location Prediction Data 1060 may mean they are combined into a single stream of data and transmitting the stream wirelessly, or transmitting the Model 1050 and Prediction Data separately at the same time, or at different times to a Remote Device 1080. Next at block 1370, Prediction Data 1360 and the Location Prediction Model 1350 are wirelessly transmitted to a Remote Device. The Remote Device is then used to wirelessly relay Utility Location Prediction Data and the Location Prediction Model to the Cloud 1375 to determine a Location Prediction Result 1380. At block 1385 at least a portion of the Prediction Result is wirelessly transmitted back to the Utility Locator or a Utility Inspection Camera Cable Drum-reel 1390 where at least a portion of the previously transmitted Location Prediction Result received by the Locator is presented to a user 1395, e.g. rendered on a display, provided as audio or tactile output, and other well known ways of providing data to a user.

Although a Utility Locator is described, a Utility Inspection Camera Cable Drum-reel with processing and/or wireless communication capabilities may be used, or both a Utility Locator and a Cable Drum-reel may be used. Multiple Locators and/or Drum-reels may also be used. Location Prediction Result information may be displayed on a Remote Device, on a Utility Locator, or on a Utility Inspection Camera Cable Drum-reel. Location Prediction Result information may also be received from a Remote Device to a Cable Drum-reel, and then relayed to a Utility Locator for storage or display.

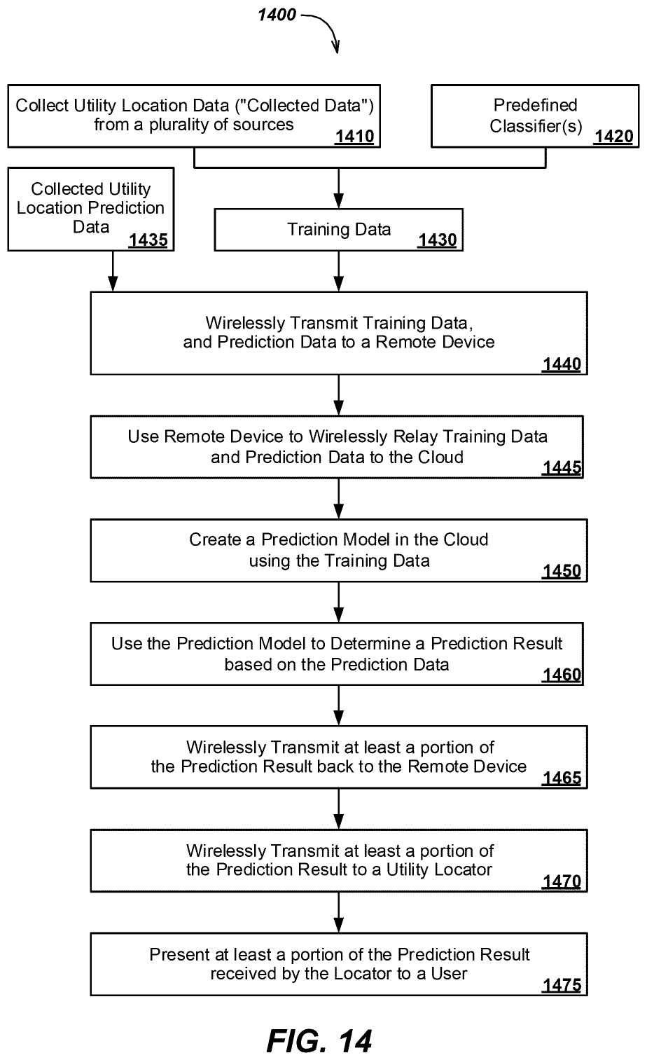

FIG. 14 illustrates details of an exemplary method 1400 of using a remote device with a utility locator to access additional conventional or AI processing resources available in the Cloud. The method starts at block 1410 collecting Utility Location Data “Collected Data” from a plurality of sources, and optionally providing Predefined Classifiers 1420, both of which are used as input for Training Data 1430. Next at block 1440, the Training Data 1430 and Utility Location Prediction Data 1435 are wirelessly transmitted to a Remote Device, and then the Remote Device is used to relay the Training Data 1440 and Prediction Data 1435 to the Cloud in block 1445. In block 1450, a Prediction Model is Created with the Training Data by using a Neural Network in the Cloud. Next, a Location Prediction Result is Determined in the Cloud with the Model and the Prediction Data 1460. Next, at least a portion of the Location Prediction Result from block 1460 is wirelessly transmitted back to the Utility Locator or a Camera Inspection Cable-Drum Reel 1470 where at least a portion of the of the previously transmitted Location Prediction Result received by the Utility Locator or a Camera Inspection Cable-Drum Reel is presented to a user 1475, e.g. rendered on a display, provided as audio or tactile output, and other well known ways of providing data to a user.

The scope of the invention is not intended to be limited to the aspects shown herein but are to be accorded the full scope consistent with the disclosures herein and their equivalents, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the present invention. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the disclosures herein and in the appended drawings.

1. A system for locating and mapping buried utilities using Artificial Intelligence (AI), comprising:
a receiving element for collecting utility location data (“collected data”) from a plurality of sources;
an input element for entering one or more predefined classifiers;
a processing element for using at least a portion of the collected data alone or in combination with one or more predefined classifiers, wherein the processor outputs training data;
a bi-directional communication element for transmitting the training data and new collected data to be predicted (“prediction data”) to a remote device, wherein the remote device includes at least one neural network for processing the training data and the prediction data using Deep Learning performed by Artificial Intelligence (AI) to determine a location prediction result;
a transceiver integrated with the remote device for wirelessly transmitting at least a portion of the prediction result to the receiving element; and
a user interface integrated with the receiving element for outputting at least a portion of the location prediction.

2. The system of claim 1, wherein the remote device comprises at least one of a smartphone, a laptop, a PC, or other wireless device.

3. The system of claim 2, where in the remote device communicates via at least one of WiFi, Bluetooth, or another wireless communication protocol.

4. The system of claim 1, further comprising at least one of a utility locator and a cable drum-reel.

5. The system of claim 4, where in the at least one utility locator and cable drum-reel comprises one or more transceivers.

6. The system of claim 1, wherein training data further includes one or more of imaging data collected from a camera or imaging element, sensor data, fiber optic data, and mapping data.

7. The system of claim 6, wherein mapping data includes at least one of depth or orientation data.

8. The system of claim 1, wherein training data further includes one or more of image data, current and/or voltage data, even and odd harmonics data, active and/or passive signal data, and spatial relationship data, phase data and phase difference data.

9. The system of claim 1, wherein training data further includes other data comprising one or more of observed data, user classification data, and ground truth data.

10. The system of claim 9, wherein ground truth data comprises one or more of ownership data, manufacturer data, connection data, utility box or junction data, and obstacle data.

11. The system of claim 1, wherein training data may be processed and classified in real-time, or stored and post-processed in the Cloud.

12. The system of claim 1, wherein classifying the collected data comprises determining at least one of a utility type, electrical characteristics, connection type, asset type, manufacturer type, ownership type, location type, direction type, right of way type, or damaged asset type.

13. The system of claim 4, wherein the at least one utility locator and/or cable drum-reel is removably attachable to a vehicle.

14. The system of claim 13, wherein the vehicle comprises a hitching mechanism to removably attach the at least one utility locator and/or cable drum-reel.

15. The system of claim 1, wherein the output element comprises one or more of a visual display, a speaker or other sound producing element, and a vibration or other tactile producing element.

16. A method for locating and mapping buried utilities using Artificial Intelligence (AI), comprising:
collecting utility location data (“collected data”) from a plurality of sources;
using the collected data alone or in combination with user predefined classifiers as training data;
providing the training data to at least one neural network to create a location prediction model by processing the training data using Deep Learning performed by Artificial Intelligence (AI);
collecting utility data to be used for a location prediction (“prediction data”);
wirelessly transmitting the prediction data and the location prediction model to at least one of a smartphone, laptop, PC, or other wireless device (“remote device”);
determining a location prediction result on the remote device using the prediction data and the location prediction model;
wirelessly transmitting at least a portion of the prediction result to a utility locator; and
presenting the at least a portion of the location prediction to a user at the locator.

17. The method of claim 16, wherein the collected data is at least one of multifrequency electromagnetic signal data, image data, or communication signal data.

18. The method of claim 17, wherein collecting the at least one of of multifrequency electromagnetic signal data and communication signal data comprises receiving the data from at least one of a locator, Sonde, transmitting antenna, receiving antenna, transceiver, inductive clamp, electrical clip, or a satellite system.

19. The method of claim 17, wherein image data is collected from a camera or imaging element.

20. The method of claim 16, wherein training data further includes at least one of sensor data, fiber optic location data.

21. The method of claim 16, wherein training data further includes mapping data.

22. The method of claim 21, wherein mapping data includes at least one of depth or orientation data.

23. The method of claim 16, wherein training data further includes fiber optic location data.

24. The method of claim 16, wherein training data further includes one or more of image data, current and/or voltage data, even and odd harmonics data, active and/or passive signal data, and spatial relationship data.

25. The method of claim 16, wherein training data further includes one or more of phase data and phase difference data.

26. The method of claim 16, wherein training data further includes other data.

27. The method of claim 26, wherein other data comprises one or more of observed data, user classification data, and ground truth data.

28. The method of claim 27, wherein ground truth data comprises one or more of ownership data, manufacturer data, connection data, utility box or junction data, and obstacle data.

29. The method of claim 16, wherein training data may be processed and classified in real-time or near real-time, or stored and post-processed in a cloud network.

30. The method of claim 16, further comprising classifying the collected data by determining at least one of a utility type, electrical characteristics type, connection type, asset type, manufacturer type, ownership type, location type, direction type, right of way type, or damaged asset type.

31. The method of claim 16, wherein presenting prediction data to a user comprises an output element including one or more of a visual display, a speaker or other sound producing element, and a vibration or other tactile producing element.

32. The method of claim 16, wherein predicted data may include visually displayed mapping data.

33-38. (canceled)
